(19) United States
(12) Patent Application Publication
(10) Pub. No.: US 2026/0288852 A1
(43) Pub. Date: Sep. 24, 2026

(54) SYSTEM

(71) Applicant: SoftBank Group Corp., Tokyo (JP)

(72) Inventor: Mikiya MARUYAMA, Tokyo (JP)

(73) Assignee: SoftBank Group Corp., Tokyo (JP)

(21) Appl. No.: 19/567,334

(22) Filed: Mar. 16, 2026

(30) Foreign Application Priority Data
Mar. 19, 2025 (JP) 2025-045128

(51) Int. Cl. G06F 16/432; G06F 16/435

(52) U.S. Cl. CPC G06F 16/433; G06F 16/435

(57) ABSTRACT

A system includes a processor that is configured to acquire elements including at least an answer content to a question, a facial expression, a posture, a clothing appearance, a tone of voice, and an accent of a user, input a prompt to a generative artificial intelligence model so as to instruct the generative artificial intelligence model to generate a score for each of the elements, integrate the generated scores for the respective elements into a comprehensive score by applying a weighting algorithm to the generated scores, and recognize an emotion of the user and analyze an emotional state of the user by using an emotion engine.

### CROSS-REFERENCE TO RELATED APPLICATION

This application is based on and claims priority under 35 USC 119 from Japanese Patent Application No. 2025-045128 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional interview support systems and evaluation tools mainly focus on limited aspects of a candidate's performance, such as manually entered scores or simple textual analysis of answers, and therefore fail to capture a holistic view that includes facial expression, posture, clothing appearance, tone of voice, and accent. As a result, interviewer evaluations can be inconsistent, subjective, and difficult to standardize across different recruiters or job positions. Furthermore, existing systems generally do not utilize generative artificial intelligence models for flexible multi-factor scoring based on prompts, nor do they provide a mechanism for recruiters to dynamically adjust the importance of each evaluation factor in accordance with specific hiring policies. In addition, there is often insufficient use of machine learning models trained on past datasets to score each element objectively, and limited capability to recognize and analyze a user's emotional state as part of the evaluation. Therefore, there is a need for a system that can comprehensively acquire multiple elements related to an interview, generate scores for these elements using a generative artificial intelligence model and machine learning models, recognize and analyze user emotions, and integrate the scores into a comprehensive score using adjustable weighting parameters so that recruiter preferences and job requirements are accurately reflected.

### SUMMARY

In order to solve the above problems, according to one aspect of the present invention, there is provided a system comprising a processor, wherein the processor is configured to acquire elements including at least an answer content to a question, a facial expression, a posture, a clothing appearance, a tone of voice, and an accent of a user, and to input a prompt to a generative artificial intelligence model so as to instruct the generative artificial intelligence model to generate a score for each of the elements. The processor is further configured to integrate the generated scores for the respective elements into a comprehensive score by applying a weighting algorithm to the generated scores, and to recognize an emotion of the user and analyze an emotional state of the user by using an emotion engine. The processor is also configured to set weighting parameters, via a user interface, so that a recruiter is able to adjust which of the elements is emphasized by the weighting algorithm, thereby allowing flexible customization of evaluation criteria. In addition, the processor is configured to perform scoring of each of the elements by using a machine learning model trained with past datasets, thereby improving objectivity and accuracy of the scoring. Through these combined features, the system can provide a comprehensive, configurable, and data-driven interview evaluation environment that addresses the shortcomings of conventional techniques.

The term “processor” refers to one or more hardware computation units, such as a central processing unit (CPU), a graphics processing unit (GPU), or a specialized accelerator, and may further include associated memory and control circuitry configured to execute instructions that implement the functions described in the claims.

The term “generative artificial intelligence model” refers to a software-implemented model, such as a neural network or large language model, that is configured to generate output data, including scores or evaluations, in response to an input prompt or other conditioning information.

The term “prompt” refers to information, including textual, symbolic, or structured input data, that is provided to a generative artificial intelligence model to instruct the model regarding a processing objective, such as generating a score for a particular element of an interview.

The term “score” refers to a numerical or categorical value that quantitatively or qualitatively represents an evaluation result for a specific element, such as answer content, facial expression, posture, clothing appearance, tone of voice, or accent.

The term “weighting algorithm” refers to a procedure or set of rules executed by the processor to combine a plurality of scores by assigning respective weights to the scores and calculating a weighted result, such as a comprehensive score.

The term “comprehensive score” refers to a combined evaluation value generated by integrating multiple individual scores for respective elements, the value representing an overall assessment of a user or an interview performance.

The term “answer content” refers to information included in a user's response to a question, including, for example, words, sentences, semantic meaning, logical structure, and topic relevance contained in the response.

The term “facial expression” refers to a state or change of a user's face, including positions or movements of facial features such as eyes, eyebrows, mouth, and cheeks, that can be analyzed to infer emotion, attitude, or engagement.

The term “posture” refers to a user's body orientation, alignment, and physical stance or movement, including, for example, sitting position, standing position, body tilt, and stability during an interview.

The term “clothing appearance” refers to visual characteristics of garments worn by a user, including type, style, formality level, cleanliness, and overall appropriateness as perceived from image or video data.

The term “tone of voice” refers to acoustic characteristics of a user's speech, including pitch, intonation, rhythm, loudness, speaking speed, and clarity, which can be used to evaluate communication style or confidence.

The term “accent” refers to pronunciation characteristics of a user's speech, including phonetic patterns, stress patterns, and intonation specific to a language variety or region, and is evaluated with respect to intelligibility or conformity to a target accent.

The term “emotion engine” refers to a functional module, implemented by software and executed by the processor, that is configured to recognize, classify, and analyze emotional states of a user based on input data such as facial expressions, voice, and textual content.

The term “emotion” refers to a psychological and affective state of a user, such as happiness, sadness, anger, anxiety, or neutrality, that can be inferred from observable signals including facial expression, voice characteristics, and behavioral indicators.

The term “emotional state” refers to a condition of a user's emotion over a period of time, including intensity, type, and variation of emotional responses, as determined or estimated by the emotion engine.

The term “user interface” refers to hardware and software components, such as graphical user interfaces, web pages, application screens, or input dialogs, that enable a user, including a recruiter, to input information and parameters and to view outputs provided by the system.

The term “weighting parameters” refers to numerical values or coefficients that specify relative importance or contribution of respective elements or scores when the weighting algorithm calculates the comprehensive score.

The term “recruiter” refers to a human user who is involved in hiring, selection, or evaluation processes, and who operates the system to review scores, adjust weighting parameters, and make decisions regarding candidates.

The term “machine learning model” refers to a software-implemented model, such as a neural network, decision tree, or ensemble model, that is trained using past datasets so as to learn relationships between input data and target labels or scores, and that is used to generate scores for the respective elements.

The term “past datasets” refers to collections of previously obtained data, including interview records, videos, audio, transcripts, and associated human-labeled scores or evaluations, which are used to train or update the machine learning model.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

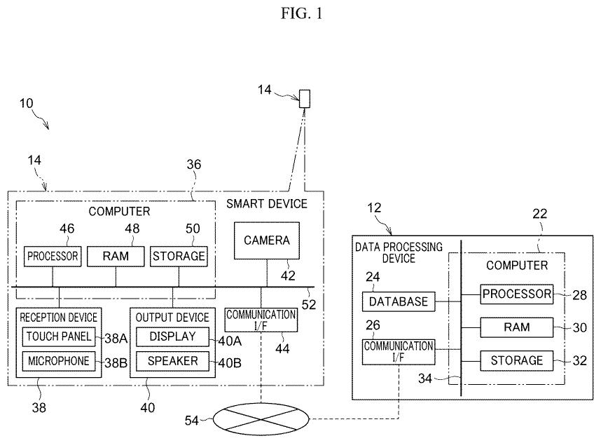

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

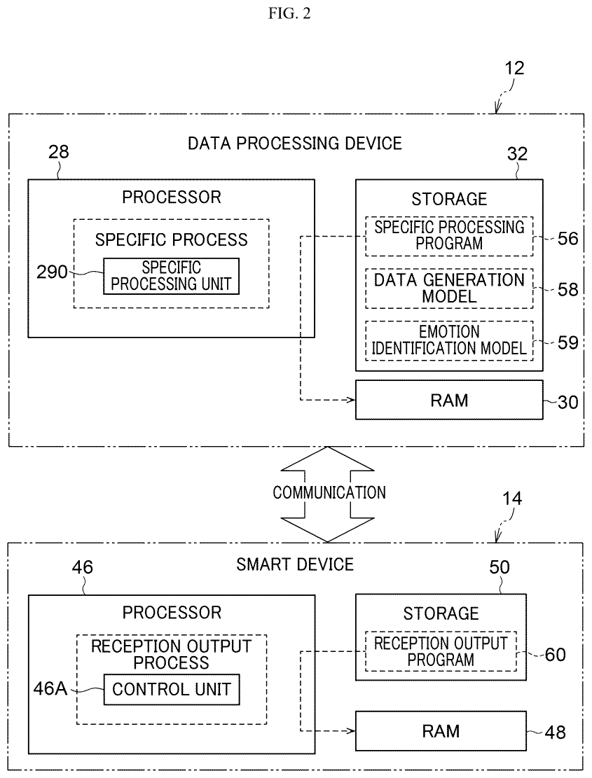

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional interview evaluation systems rely heavily on human subjective judgment and ad hoc qualitative criteria. Even when digital tools are used to record video or audio of an interview, the underlying computing processes typically treat such recordings as static content, and do not systematically convert multimodal behavioral signals into structured data that can be processed in a consistent, machine-assisted manner. As a result, computing resources are used primarily for storage and playback, rather than for improving the quality, consistency, and efficiency of the evaluation process itself.

Furthermore, known scoring systems that use machine learning often operate on narrowly defined inputs, such as text-only answers or simple rating forms, and do not fully exploit rich audiovisual signals such as facial expressions, gaze, posture, tone, fluency, and pronunciation. These systems frequently apply fixed heuristic rules or pre-trained models in isolation, without dynamically coordinating multiple processing components. In particular, they do not provide a mechanism by which a computer system can automatically assemble heterogeneous features into a structured representation, generate a prompt sentence tailored to those features, and then leverage a generative AI model to produce element-wise scores and explanatory comments in a way that improves downstream machine processing. This leads to fragmented processing pipelines, limited adaptability across different interview scenarios, and burdensome manual interpretation by human users.

In addition, existing systems often perform scoring and explanation generation as separate, loosely coupled tasks. Element scores may be computed by one model, while free-form text feedback is written manually or by a different tool, resulting in inconsistencies between numerical outputs and narrative explanations. Weighting of different evaluation elements is also typically hard-coded, or configured through simplistic interfaces that do not deeply integrate with the underlying computation. This lack of tight integration prevents the system from effectively personalizing scoring logic in response to different evaluation policies, and reduces the transparency and auditability of the scoring process from a computational standpoint.

From a computer technology perspective, there is a need for a system that treats multimodal interview data as first-class computational input, and that coordinates computer vision, speech processing, natural language processing, discriminative machine learning models, and generative AI models within a unified, data-driven pipeline. Such a system should configure a processor to (i) transform raw time-series audiovisual streams into structured feature representations, (ii) dynamically construct prompt sentences for a generative AI model based on these representations, (iii) obtain element-wise scores and explanatory comments from the generative AI model, and (iv) algorithmically integrate those outputs into a comprehensive score with tunable weighting and emotion indices. By doing so, the system can improve the functionality of the computer as a technical tool: the processor performs more efficient, consistent, and context-aware analysis of complex multimodal data, reduces manual post-processing, and provides machine-readable outputs that can be reused and audited programmatically.

Accordingly, an object of the present invention is to provide a computer-implemented system that improves how a processor acquires, structures, and processes interview-related audiovisual information, automatically generates and manages prompt sentences for a generative AI model, and integrates the resulting scores and narrative evaluations into a coherent, tunable scoring architecture. This addresses technical problems of fragmented processing, rigid scoring logic, and inefficient use of multimodal data, thereby enhancing the performance, reliability, and scalability of the underlying computing system.

The specific processing by the specific processing unit 290 of the data processing device 12 in Example 1 is realized by the following means.

The present invention provides a server comprising a processor configured to acquire time-series audiovisual data related to a subject from at least one input/output device, to analyze image data included in the audiovisual data by using image processing software so as to extract feature information indicating at least a facial expression state, a gaze state, a head posture state, a body posture state, and an apparel state of the subject, to analyze an audio signal included in the audiovisual data by using speech recognition software so as to obtain audio text data and acoustic feature information and to extract feature information indicating at least a tone state, a fluency state, and a pronunciation state of the subject, to apply natural language processing software to the audio text data so as to extract semantic feature information indicating at least a structure, a relevance, a concreteness, and a consistency of answer content of the subject, to convert a plurality of feature information including the facial expression state, the gaze state, the head posture state, the body posture state, the apparel state, the tone state, the fluency state, the pronunciation state, and the semantic feature information into machine-readable input data according to a predetermined data structure, to dynamically generate a prompt sentence that instructs a generative information processing model to perform scoring of respective elements and to generate an evaluation comment, and to input the prompt sentence and the machine-readable input data into the generative information processing model, to analyze element scores and the evaluation comment obtained from the generative information processing model and to apply a weighting algorithm to the element scores so as to calculate a comprehensive score, to use emotion analysis software based on the plurality of feature information so as to generate an emotion index indicating an emotional state of the subject, and to store the comprehensive score, the element scores, the evaluation comment, and the emotion index in a storage device and to output them to a human user as an evaluation result via an output device. This enables the computing system to perform an integrated, multimodal analysis of interview data, to automatically construct and utilize structured prompt sentences for a generative AI model, and to algorithmically generate consistent, machine-readable scores and explanations, thereby improving the technical functioning of the processor in processing complex audiovisual information and reducing reliance on manual, ad hoc evaluation procedures.

The term “time-series audiovisual data” refers to a sequence of digital data elements that include both image information and audio information associated with respective points or intervals in time, such that temporal changes in the subject's appearance and voice can be analyzed.

The term “input/output device” refers to an electronic apparatus, such as a camera, a microphone, a display, or a combination thereof, that is configured to capture information from a subject and/or present information to a human user or another system.

The term “subject” refers to a human individual who is being interviewed or evaluated and whose audiovisual data are captured and processed by the system.

The term “image processing software” refers to executable instructions that, when executed by a processor, perform operations on digital image data, including at least detection, localization, and analysis of regions corresponding to a face, a body, or clothing of the subject.

The term “speech recognition software” refers to executable instructions that, when executed by a processor, convert an audio signal containing human speech into corresponding text data and optionally generate acoustic feature information such as timing, pitch, or energy.

The term “natural language processing software” refers to executable instructions that, when executed by a processor, analyze text data representing human language to extract structural, semantic, or syntactic information, including entities, topics, relationships, and logical organization.

The term “facial expression state” refers to feature information representing a condition or pattern of movements of facial components of the subject, including at least the eyes, eyebrows, and mouth, which correspond to emotional expressions such as smiling, neutrality, or surprise.

The term “gaze state” refers to feature information representing an orientation or direction of a line of sight of the subject, including whether the subject is looking toward the camera, away from the camera, or frequently shifting eye direction.

The term “head posture state” refers to feature information representing an orientation and movement of a head of the subject relative to a reference direction, including pitch, yaw, and roll angles over time.

The term “body posture state” refers to feature information representing a position, alignment, and movement of a torso, shoulders, or overall body of the subject relative to a reference position, including slouching, leaning, or stable upright posture.

The term “apparel state” refers to feature information representing visual characteristics of clothing and accessories worn by the subject, including at least formality level, neatness, and presence of items associated with a professional or non-professional appearance.

The term “tone state” refers to feature information representing characteristics of the subject's voice such as pitch range, loudness, and emotional coloration, which influence perceived speaking style.

The term “fluency state” refers to feature information representing a continuity and smoothness of the subject's speech, including speech rate, frequency of pauses, and presence of disfluencies such as repeated words or filler sounds.

The term “pronunciation state” refers to feature information representing clarity and correctness of articulation of phonetic units in the subject's speech relative to a reference language model.

The term “audio text data” refers to text information generated by converting an audio signal containing human speech into a character-based or token-based transcription.

The term “acoustic feature information” refers to numerical or symbolic data derived from an audio signal, including at least time-based, frequency-based, and energy-based measures such as pitch, intensity, and spectral characteristics.

The term “semantic feature information” refers to data representing meaning-related properties of an answer, including at least topic coverage, logical structure, relevance to a given question, and degree of detail or specificity.

The term “answer content” refers to information expressed by the subject in response to an interview question, as represented by the audio text data and associated semantic feature information.

The term “machine-readable input data” refers to data encoded in a structured format suitable for direct processing by a computer program, such as a vector, a table, or a hierarchical data object with predefined fields.

The term “predetermined data structure” refers to a defined format or schema that specifies how feature information is organized, including field names, data types, and relationships, such that different processing components can interpret the data consistently.

The term “feature information” refers to data elements extracted from raw audiovisual input, representing measurable properties or characteristics of the subject's appearance, behavior, or speech, which are suitable for computational analysis.

The term “generative information processing model” refers to a trained computational model that, in response to input data and a prompt sentence, generates new output data such as scores, text, or other structured information, based on learned statistical patterns.

The term “prompt sentence” refers to text or a sequence of tokens that encodes an instruction, a question, or contextual information provided to the generative information processing model to control or guide a generation operation.

The term “element scores” refers to numerical values that quantify evaluation results for respective evaluation elements, including at least facial expression, gaze, head posture, body posture, apparel, tone, fluency, pronunciation, and answer content.

The term “evaluation comment” refers to a natural-language description generated by the generative information processing model or another processing module, which explains or summarizes evaluation results related to the subject.

The term “weighting algorithm” refers to a computational procedure that combines a plurality of element scores using one or more weighting parameters to compute a combined value such as a comprehensive score.

The term “comprehensive score” refers to a numerical value representing an overall evaluation of the subject, obtained by aggregating the element scores according to the weighting algorithm.

The term “emotion analysis software” refers to executable instructions that, when executed by a processor, analyze feature information derived from audiovisual data to estimate an emotional state of the subject.

The term “emotion index” refers to numerical or categorical data representing an estimated emotional state of the subject, such as levels of stress, confidence, or positivity, derived from emotion analysis software.

The term “learning information processing model” refers to a computational model that has been trained using machine learning techniques on training data including audiovisual data, feature information, and associated evaluation labels, such that the model can output numerical values or predictions for new input data.

The term “evaluation labels” refers to ground-truth or reference evaluation data, such as scores or classifications provided by human experts or prior systems, used for training or validating the learning information processing model.

The term “user interface” refers to a combination of hardware and software components, including at least a display device and an input device, that enables a human user to interact with the system, configure parameters, and view evaluation results.

The term “weighting parameters” refers to adjustable numerical values that determine relative contributions of respective element scores when the weighting algorithm calculates the comprehensive score.

The term “storage device” refers to a memory component or subsystem, such as a non-volatile memory or a database system, configured to store data including audiovisual data, feature information, scores, comments, and emotion indices.

The term “output device” refers to a hardware component, such as a display, a printer, or a network interface, used to present evaluation results or other information from the system to a human user or an external system.

In one embodiment, a server, a terminal, and a user cooperate to implement the claimed system. The server comprises at least one hardware processor, a main memory, a non-volatile storage device, and a network interface. The terminal comprises a processor, a display, a camera, a microphone, an input device such as a keyboard or a pointing device, and a communication interface. The user operates the terminal to conduct an interview and to review an evaluation result.

The terminal uses a camera and a microphone to capture time-series audiovisual data of a subject. The terminal executes a browser application or a dedicated interview application to access a web service provided by the server. The terminal encodes captured video using a video codec such as H.264 and encodes audio using a codec such as Opus or AAC. The terminal encapsulates encoded video frames and audio samples into packets with timestamps and a session identifier, and transmits these packets to the server through a network interface using a network protocol such as HTTPS or a real-time communication protocol such as WebRTC.

The server receives the audiovisual data, stores the data temporarily in a storage subsystem, and controls a set of software modules to analyze the data. In one implementation, the server runs an operating system such as a general-purpose server operating system on a cloud computing platform, and executes software frameworks such as a numerical computation library, a machine learning library, and a deep learning library. The server uses an image processing framework such as an open-source computer vision library to decode and process video frames, and uses a speech recognition service accessed through an application programming interface to convert audio into text.

The server uses image processing software to detect a face and a body of the subject from each received video frame. The server can apply a convolutional neural network-based detector to identify a bounding box of the face and multiple landmarks such as eye corners, mouth corners, and nose tip. The server computes a facial expression state by mapping the relative positions and movements of these landmarks to an emotion space, for example by passing normalized landmark vectors into a trained multilayer neural network that outputs probabilities for classes such as happiness, neutrality, or nervousness. The server computes a gaze state by estimating a direction vector of the eyes relative to the camera axis, and computes a head posture state by estimating yaw, pitch, and roll angles using a 3D head pose estimation algorithm. The server computes a body posture state by detecting keypoints such as shoulders, neck, and hips using a pose estimation network, and derives metrics such as slouching degree and body alignment stability from temporal changes in these keypoints. The server computes an apparel state by cropping upper-body regions and applying a deep convolutional classifier trained to assign labels such as formal, semi-formal, or casual, with associated confidence scores.

The server uses speech recognition software to decode the audio signal into audio text data and to generate acoustic feature information such as per-frame energy, fundamental frequency, and spectral coefficients. The server can call a network-based speech recognition service that returns a transcript with word-level timestamps and recognition confidences. The server derives a tone state from pitch and energy contours by computing statistics such as average pitch, pitch variance, and loudness range over segments aligned with answers. The server derives a fluency state by computing speech rate, pause duration distribution, and number of filled pauses, using alignment between the transcript and the audio waveform. The server derives a pronunciation state by computing a phoneme-level error rate or mispronunciation likelihood, using an alignment between predicted phoneme sequences and reference phoneme models for a target language.

The server uses natural language processing software to analyze the audio text data. In one embodiment, the server uses a language processing library or a transformer-based language model to segment the transcript into sentences, identify parts of speech, extract named entities, and compute semantic similarity between the subject's answer and predefined reference descriptions for each interview question. The server thus derives semantic feature information such as coverage of required topics, logical structure of the explanation, relevance to the asked question, and degree of concreteness, for example measured as a density of specific entities, time expressions, and quantifiable details.

The server converts the above-described feature information into machine-readable input data according to a predetermined data structure. In one embodiment, the server uses a structured object that includes fields for each category, such as facial_expression_features, gaze_features, head_pose_features, body_posture_features, apparel_features, tone_features, fluency_features, pronunciation_features, and semantic_features. Each field contains a vector of numerical values such as means, variances, and frequency counts over defined time windows, and includes metadata such as timestamps linked to specific interview questions. The server normalizes each feature to a common numerical range by applying z-score normalization or min-max scaling learned from a training dataset, which stabilizes subsequent processing and improves convergence of learning models.

The server dynamically generates a prompt sentence for a generative AI model based on the machine-readable input data. The server constructs the prompt sentence by inserting selected feature summaries and preliminary scores into a text template stored in a prompt generation module. In one specific example, the server generates a prompt sentence such as: “Act as an interview evaluation assistant. You receive the following numeric scores and feature summaries from automated analysis of a candidate's interview.
Expression score: 8.5
Posture score: 7.0
Clothing score: 9.0
Tone score: 8.0
Accent_fluency score: 7.5
Content_quality score: 8.0
Initial comprehensive score (0-100): 84

Key features: frequent smiling, stable gaze toward camera, upright posture with minor fidgeting, formal clothing, moderate speech rate with few fillers, clear structure and relevant examples in answers.

1. Briefly describe the candidate's strengths and weaknesses.

2. State whether the initial comprehensive score should be adjusted within +5 points, and give the final score.

3. Output JSON with fields ‘final_score’ and ‘comment’.”

In another example, the server generates a prompt sentence focusing on a single answer: “The following is a candidate's answer to the interview question ‘Please introduce yourself.’ Evaluate clarity, relevance to the job, structure, and level of detail on a scale of 0 to 10. Return JSON with fields clarity_score, relevance_score, structure_score, detail_score, and a brief comment. Answer: [transcript text].”

The server sends the prompt sentence, along with a compact numerical representation of features, to a generative AI model implemented as a large neural network. In one configuration, the generative AI model is a transformer-based sequence model with multiple attention layers, pre-trained on large text corpora and fine-tuned on evaluation-focused datasets. The server transmits inputs via an application programming interface over a secure network connection, receives generated text, and parses element scores and evaluation comments embedded in the output.

The server also uses a separate learning information processing model to compute element scores from raw features. In one embodiment, the server uses a deep neural network that includes an input layer corresponding to the concatenated feature vector, several hidden layers with non-linear activation functions, and an output layer that produces multiple element scores simultaneously. The server trains this model offline using a set of training examples consisting of audiovisual data segments, extracted features, and human-labeled scores for expression, posture, apparel, tone, fluency, pronunciation, and content quality. During training, the server minimizes a loss function such as a weighted sum of mean squared error across all elements, using an optimization algorithm such as stochastic gradient descent with momentum or an adaptive learning rate method. The server updates network weights iteratively, applies regularization such as dropout and L2 penalties, and may perform data augmentation by artificially introducing variations in lighting, background noise, or speaking rate to improve robustness.

The server uses outputs of the learning model as primary element scores, and uses the generative AI model to refine or cross-check these scores and to generate narrative explanations. This division of roles allows the system to leverage discriminative models for efficient numeric prediction and a generative model for high-level reasoning and explanation, while maintaining a consistent data flow and explicit control over which data are used for which purpose.

The server applies a weighting algorithm to element scores to compute a comprehensive score. The server maintains a set of weighting parameters stored in a configuration table in a database. The user uses a user interface displayed on the terminal to view and modify these weighting parameters. For example, the user can increase a weight for content quality and decrease a weight for apparel, which the server reflects in subsequent computations. The server retrieves current weighting parameters and computes a linear or non-linear combination of element scores to produce a comprehensive score in a fixed range, such as 0 to 100. The server can also apply calibration functions, such as mapping raw scores through a sigmoid or piecewise-linear function, to correct for biases observed in historical data.

The server computes an emotion index by applying emotion analysis software to a subset of visual and audio features. In one embodiment, the server uses a recurrent neural network or temporal convolutional network that takes as input time-series sequences of facial expression probabilities, pitch contours, and speech energy patterns, and outputs scores for emotional dimensions such as stress, confidence, and engagement. The server trains this emotion model using labeled data where human raters have annotated emotional states based on audiovisual clips. By integrating sequences rather than frame-level snapshots, the server improves sensitivity to temporal patterns such as increasing nervousness or stabilizing confidence, which produces a more accurate emotion index.

The terminal presents the comprehensive score, element scores, evaluation comments, and emotion index on a graphical interface. The terminal receives structured result data from the server via a network protocol and renders charts, tables, and text summaries. The user can interact with the interface to view details for each question, inspect time-series plots of features such as smile intensity or speech rate, and compare multiple subjects. The terminal sends any user adjustments or feedback back to the server, which optionally stores such feedback alongside automated results for model retraining.

This configuration yields concrete technical improvements over conventional systems. The server reduces network and storage loads by encoding and chunking audiovisual data efficiently, and by converting raw streams into compact feature vectors that can be reused across different models without re-decoding. The server improves processing speed and throughput by decomposing analysis into specialized modules (vision, audio, language, scoring, generation) and by using pre-normalized, fixed-size feature vectors as inputs to neural networks, which allows for batch processing and hardware acceleration on specialized processors.

The server improves accuracy and robustness of evaluation by combining multiple independent data sources-facial features, posture, acoustic characteristics, and semantic content-within a coherent data structure and by applying machine-learned models tuned to this structure. This approach differs from simple human-like scoring, because the system exploits high-dimensional feature spaces and non-linear interactions among features that are not practically accessible to human raters. For example, the learning model can learn that a combination of stable gaze, moderate speech rate, and specific topic coverage is more predictive of performance than any single feature alone.

The server also improves computer technology by formalizing and automating prompt generation for the generative AI model. Instead of manually crafting prompts for each evaluation, the server constructs prompt sentences based on structured feature summaries and preliminary scores. This reduces ambiguity, stabilizes generative behavior, and allows the system to achieve consistent responses from the generative AI model across different sessions. The combination of structured feature input and structured prompt design improves computational predictability and reduces the need for ad hoc human intervention.

The system further differs from a mere automation of human judgment by applying non-intuitive computational procedures, such as using temporal convolution over feature sequences, applying feature normalization learned from large-scale data, and jointly training multi-output networks that optimize multiple evaluation criteria simultaneously. These procedures produce quantifiable improvements in error rates, reduce variance in scoring across sessions, and enable rapid processing of large volumes of interviews that would not be practically processable by human evaluators alone.

In another embodiment, the server can run on an edge computing node located near the terminal, which reduces end-to-end latency and preserves privacy by performing feature extraction locally and sending only anonymized feature vectors to a central generative AI service. In yet another embodiment, the generative AI model can run on-premises within the same data center as the feature extraction modules, allowing tighter control over data flow and further reductions in network traffic. In a variation, the system can support alternative neural network architectures, such as graph neural networks for modeling relationships between facial landmarks or transformers for modeling long-range temporal dependencies in behavior.

The server can adapt the format and content of prompt sentences depending on target use cases. For example, for technical interviews, the prompt sentence may emphasize logical structure and problem-solving steps; for customer-facing roles, it may emphasize tone, empathy indicators, and politeness markers in the transcript. The same underlying architecture can therefore support multiple domains by adjusting feature selection, weighting parameters, and prompt templates, while keeping the core data structures and computational modules consistent.

Through these embodiments and variations, the server, the terminal, and the user jointly implement a system that not only automates parts of interview evaluation but also improves the underlying computer technology for acquiring, structuring, transmitting, and processing multimodal data, and for coordinating discriminative and generative AI models via systematically constructed prompt sentences.

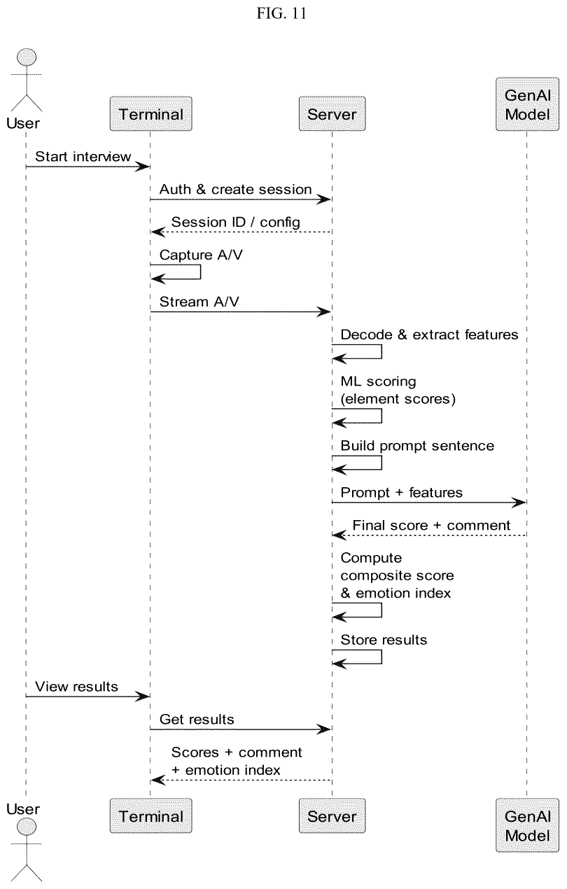

The following describes the processing flow using FIG. 11.

### Step 1:

The user prepares the interview environment.

The user operates the terminal to launch a browser or dedicated interview application and logs into a service provided by the server. The terminal sends an authentication request and user credentials to the server as input. The server verifies the credentials, creates an interview session record in a database, generates a unique session ID, and returns configuration data (for example, media constraints, endpoint URLs, and time limits) as output. Based on this output, the terminal configures access to a camera and a microphone using operating system media APIs.

### Step 2:

The terminal captures and transmits audiovisual data.

The terminal activates the camera and microphone and begins capturing raw video frames and raw audio samples as input. The terminal performs data processing by encoding the raw video using a video codec (for example, H.264) and the audio using an audio codec (for example, Opus), and by packetizing encoded media into small chunks with timestamps and the session ID. The terminal outputs these encoded and timestamped chunks through a network interface using a communication protocol such as WebRTC or HTTPS and transmits them to the server.

### Step 3:

The server receives and buffers audiovisual streams.

The server receives encoded video and audio packets from the terminal as input via secure endpoints. The server validates the session ID and integrity of each packet, decodes metadata such as timestamps, and writes the packets into a media buffer or message queue. The server optionally stores the encoded media in persistent storage (for example, as files or objects keyed by session ID and timestamp). The server outputs references to buffered media segments (such as file paths or keys) and decoded media streams to downstream processing modules.

### Step 4:

The server extracts frames and pre-processes images.

The server takes decoded video frames or encoded video segments as input. The server decodes the video into individual frames using image processing software and resizes each frame to a standard resolution (for example, 224×224 pixels) and color format, and normalizes pixel values. The server applies a face detector and a body region detector to locate a face bounding box and upper-body region in each frame. The server outputs cropped face images and cropped upper-body images, along with position metadata for each frame, as pre-processed image data for further analysis.

### Step 5:

The server detects landmarks and posture features.

The server receives cropped face and body images as input. The server applies a facial landmark detection model to identify specific points such as eyes, eyebrows, nose, and mouth corners. The server computes a facial expression state by transforming landmark coordinates into feature vectors and feeding them into a trained neural network that outputs probabilities of different expressions. In parallel, the server uses a pose estimation model on body images to locate body keypoints such as shoulders and neck, and calculates body posture angles and movement metrics. The server outputs numerical feature vectors representing facial expression state, gaze state, head posture state, and body posture state for each time segment.

### Step 6:

The server analyzes apparel features.

The server uses representative upper-body frames selected at stable time intervals as input. The server feeds each cropped upper-body image into a deep learning-based apparel classifier that has been trained to distinguish apparel categories and formality levels. The server calculates an apparel state by mapping classifier probabilities to a numerical scale (for example, formal, semi-formal, casual) and aggregating results over multiple frames to reduce noise. The server outputs an apparel feature vector and an intermediate apparel score associated with the session.

### Step 7:

The server decodes audio and extracts acoustic features.

The server receives encoded audio chunks as input and decodes them into raw audio waveforms. The server segments the waveform into analysis windows (for example, 20-30 ms) and computes acoustic features, such as short-time energy, fundamental frequency, spectral centroid, and Mel-frequency cepstral coefficients, using an audio analysis library. The server outputs time-aligned acoustic feature sequences and corresponding audio segments as input to both speech recognition and prosody analysis modules.

### Step 8:

The server performs speech recognition and generates transcripts.

The server takes raw or segmented audio data as input. The server sends the audio segments to a speech recognition service through an API, specifying language and model parameters. The speech recognition service returns transcripts, word-level timestamps, and confidence scores, which the server receives as output. The server aligns the transcripts with audio time segments based on timestamps and constructs continuous audio text data for each question-answer interval. The server outputs text transcripts and alignment metadata to later stages.

### Step 9:

The server derives tone, fluency, and pronunciation features.

The server receives acoustic feature sequences and transcripts as input. The server computes a tone state by aggregating pitch and energy statistics over segments (for example, mean pitch, pitch variability, and loudness range). The server computes a fluency state by calculating metrics such as words per minute, average pause length detected from low-energy intervals, and frequency of filler expressions identified in the transcript. The server computes a pronunciation state by comparing phoneme sequences inferred from the audio against target phoneme patterns using a phoneme alignment model. The server outputs numerical feature vectors representing tone state, fluency state, and pronunciation state for each answer segment and for the overall session.

### Step 10:

The server computes semantic features of answer content.

The server takes text transcripts and question identifiers as input. The server uses natural language processing software to segment the text into sentences, tag parts of speech, and extract entities and key phrases. The server compares extracted content with predefined reference patterns or topic lists associated with each question using similarity measures. The server then derives semantic feature information such as topic coverage score, structural coherence score, relevance score to the question, and concreteness score based on the density of specific entities and examples. The server outputs a semantic feature vector for each answer and an aggregated semantic profile for the entire session.

### Step 11:

The server constructs a unified feature representation.

The server receives all visual, acoustic, and semantic feature vectors as input. The server normalizes each feature dimension using scaling parameters computed during a training phase and concatenates the normalized vectors into a unified feature vector structure that follows a predetermined schema. The server may also compute summary statistics over the entire interview, such as averages, variances, and maxima for each feature category, and place these values into designated fields. The server outputs unified feature vectors for each answer and/or for the entire session, and stores them in a feature database indexed by the session ID.

### Step 12:

The server computes primary element scores using a learning model.

The server takes unified feature vectors as input and feeds them into a trained learning information processing model, for example a feedforward neural network or a gradient-boosted decision tree ensemble. The model applies learned weights and non-linear activation functions to map input features to multiple outputs corresponding to element scores such as expression, posture, apparel, tone, fluency, pronunciation, and content quality. The server performs the forward pass of the model to compute these outputs and may apply post-processing (for example, clipping or scaling to a 0-10 range). The server outputs a vector of primary element scores for each session.

### Step 13:

The server generates a prompt sentence for a generative AI model.

The server receives the primary element scores and selected summary features as input. The server formats these inputs into human-readable fragments, such as “Expression score: 8.5” and “Key features: frequent smiling, stable gaze toward camera.” The server inserts these fragments into a stored text template to produce a prompt sentence. For example, the server can output the following prompt sentence:
“Act as an interview evaluation assistant. You receive the following numeric scores and feature summaries from automated analysis of a candidate's interview.
Expression score: [value]
Posture score: [value]
Clothing score: [value]
Tone score: [value]
Accent_fluency score: [value]
Content_quality score: [value]
Initial comprehensive score (0-100): [value]

### Key Features: [Summary].

1. Briefly describe the candidate's strengths and weaknesses.

2. State whether the initial comprehensive score should be adjusted within ±5 points, and give the final score.

3. Output JSON with fields ‘final_score’ and ‘comment’.”

The server outputs this prompt sentence and a compact numerical representation of features as input to a generative AI model endpoint.

### Step 14:

The server obtains refined scores and evaluation comments from the generative AI model. The server sends the prompt sentence and associated context data to the generative AI model as input via an API. The generative AI model processes the prompt and returns a textual response that includes a proposed final score and an evaluation comment. The server receives this response as output and parses it by identifying numerical values and text segments. The server validates the range of the final score (for example, enforcing an allowed adjustment window relative to the initial score) and extracts the evaluation comment as a separate text field. The server outputs a refined comprehensive score and a narrative evaluation comment.

### Step 15:

The server calculates a comprehensive score using a weighting algorithm.

The server takes the primary element scores and any refined final score suggestion from the generative AI model as input. The server retrieves current weighting parameters from a configuration store and applies a weighting algorithm, such as a weighted sum or a learned regression function, to combine the element scores into a comprehensive score. If the generative AI suggestion is within an allowed range, the server may adjust the calculated comprehensive score accordingly. The server outputs the final comprehensive score as a single numeric value associated with the session.

### Step 16:

The server computes an emotion index from temporal features.

The server receives temporal sequences of facial expression probabilities, pitch values, and energy levels as input. The server feeds these sequences into an emotion analysis model, for example a recurrent neural network configured to detect patterns indicative of stress, confidence, and engagement. The model outputs probability or intensity scores for each emotional dimension over the duration of the interview. The server aggregates these scores into an emotion index vector (for example, average stress level, peak stress, average confidence). The server outputs the emotion index as structured data linked to the session.

### Step 17:

The server stores evaluation results.

The server takes the final comprehensive score, element scores, evaluation comment, and emotion index as input. The server writes these values into persistent storage, such as a relational database or document store, using tables or collections keyed by session ID, user ID, and timestamp. The server also records references to original audiovisual data and feature vectors to maintain traceability. The server outputs confirmation of successful storage and makes the stored records available for later retrieval and analysis.

### Step 18:

The server provides evaluation results to the terminal.

The server receives a result retrieval request from the terminal, including the session ID, as input. The server queries the storage subsystem to obtain the corresponding comprehensive score, element scores, evaluation comment, and emotion index. The server formats these data into a structured response, such as a JSON document containing numeric fields and text fields, and transmits the response to the terminal. The server outputs this structured evaluation result for presentation on the terminal.

### Step 19:

The terminal displays results and accepts user feedback.

The terminal receives the structured evaluation result from the server as input. The terminal renders graphical elements such as bar charts for element scores, a numeric display for the comprehensive score, and text blocks showing the evaluation comment and emotion index explanation. The user reviews these outputs, and optionally enters feedback or adjusts recommendation-level fields through input controls. The terminal packages user feedback as structured data and sends it back to the server. The terminal outputs updated feedback information that can be used by the server to refine models or configuration in future sessions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In industrial and organizational environments, computer systems are increasingly used to evaluate human performance and safety. Conventional evaluation systems typically rely on single-modal or low-dimensional input data, such as textual answers to questions or manually entered ratings, and apply simple rule-based or statistical post-processing. Such systems suffer from several technical problems.

First, conventional systems are not designed to continuously acquire and process heterogeneous, time-series sensor data, such as facial images and voice signals captured by wearable devices, in a coordinated manner. As a result, these systems cannot construct a unified, machine-interpretable representation of a worker's state that faithfully reflects complex real-world conditions, and they therefore exhibit low robustness and low precision in their automated assessments.

Second, in many existing architectures, each modality (for example, image data or audio data) is processed in isolation and combined only by fixed, hard-coded logic in application software. This leads to rigid system behavior and makes it difficult to adapt the evaluation logic to different tasks, environments, or evaluation policies. Customizing the relative importance (weighting) of different evaluation elements, such as facial expression, posture, and voice characteristics, often requires manual code changes or database configuration changes, causing maintenance overhead and limiting scalability.

Third, some systems attempt to incorporate machine learning models for scoring, but they are generally implemented as black-box subroutines that accept raw sensor input and output a single aggregate score. In such systems, the underlying feature extraction and score aggregation pipelines are not explicitly structured around generative artificial intelligence models and prompt sentences. Consequently, the systems cannot flexibly generate richer intermediate outputs, such as element-wise scores and explanatory text, and cannot leverage the expressive capability of generative models to dynamically tailor evaluations based on contextual instructions.

Fourth, existing client-server architectures often do not provide an integrated mechanism whereby a server continuously (i) acquires time-series sensor streams from a portable information terminal, (ii) extracts multi-modal feature vectors, (iii) constructs prompt sentences including evaluation instructions, (iv) invokes a generative artificial intelligence model to obtain element scores and integrated scores, and (v) stores and serves these scores as time-series data to a manager-facing visualization interface. As a result, it is difficult to implement near real-time monitoring and to provide managers with a coherent, time-aligned view of performance and safety indicators for decision-making.

Furthermore, conventional systems typically do not expose, at the system level, a user interface through which a recruiter or manager can adjust weighting parameters that control how different element scores are combined into an integrated score. This prevents the computer system from efficiently supporting diverse evaluation policies and reduces the utility of the system in environments where evaluation priorities change over time. Accordingly, there is a need for an improved computer-implemented system and server architecture that (i) continuously collects multi-modal sensor data from wearable terminals, (ii) converts such data into structured feature vectors, (iii) dynamically constructs prompt sentences and feeds both feature vectors and prompt sentences into a generative artificial intelligence model, (iv) generates element-wise scores and integrated scores reflecting emotional state, work efficiency, and safety, (v) stores these scores as time-series data, and (vi) provides configurable weighting and visualization mechanisms. Such a system should improve the technical functioning of the computer system itself by providing a specific, concrete data processing pipeline and model interaction scheme that increases the accuracy, adaptability, and timeliness of automated human-state evaluation.

The specific processing by the specific processing unit 290 of the data processing device 12 in Application Example 1 is realized by the following means.

The present invention provides a server comprising a processor configured to receive, from a portable information terminal worn by a worker, time-series image data and time-series audio data acquired by an imaging device and an audio acquisition device, to apply an image processing program to the image data to detect a face region and a body region of the worker and to extract facial feature information and posture feature information, to apply a speech recognition program and an acoustic analysis program to the audio data to extract text information and acoustic feature information, to generate, for each of a plurality of evaluation elements including at least an answer content to a question, a facial expression, a body posture, an appearance, a speaking style, and a speech accent, a feature vector based on the facial feature information, the posture feature information, the acoustic feature information, and the answer content, to construct a prompt sentence including the feature vector and an evaluation instruction and to input the prompt sentence and the feature vector into a generative artificial intelligence model so as to cause the generative artificial intelligence model to output an element score for each of the evaluation elements and an integrated score, to apply a weighting algorithm to the element scores to calculate the integrated score and to analyze an emotional state of a user and at least one of work efficiency and safety of the worker based on the integrated score, and to store the element scores and the integrated score as time-series data in a storage device and to provide the time-series data to an information display device for a manager. This enables a concrete improvement of computer technology by defining a specific multi-modal data acquisition and processing pipeline that unifies sensor-level feature extraction, prompt-based interaction with a generative artificial intelligence model, algorithmic score integration, and time-series storage and visualization, thereby allowing the server to generate more accurate, context-aware, and configurable assessments of human emotional state, work efficiency, and safety in near real time.

The term “processor” refers to a hardware or virtual computing unit, such as a central processing unit or a programmable control circuit, that executes instructions to perform data acquisition, analysis, and control operations in the system.

The term “portable information terminal” refers to a wearable or mobile electronic apparatus, such as smart glasses or a handheld device, that includes at least an imaging device, an audio acquisition device, a communication interface, and a control unit, and that is configured to acquire and transmit sensor data related to a worker.

The term “imaging device” refers to an optical sensing component, such as a digital camera module, configured to capture image or video data representing at least a face region or a body region of a person.

The term “audio acquisition device” refers to an acoustic sensing component, such as a microphone, configured to capture sound signals including spoken voice of a person. The term “server” refers to a computing apparatus, which may be implemented on one or more physical or virtual machines, configured to receive data from the portable information terminal, to execute data processing programs, and to provide processed information to one or more client devices.

The term “image data” refers to digital data representing still images or video frames acquired by the imaging device and including pixel values or equivalent visual information. The term “audio data” refers to digital data representing sound signals acquired by the audio acquisition device and including sampled waveform values or equivalent acoustic information.

The term “image processing program” refers to software or firmware instructions executed by the processor to perform operations on image data, such as detection of a face region, detection of a body region, extraction of facial features, and extraction of posture features. The term “speech recognition program” refers to software or firmware instructions executed by the processor to convert audio data including speech into text information representing recognized words or phrases.

The term “acoustic analysis program” refers to software or firmware instructions executed by the processor to analyze audio data and to extract acoustic feature information, such as pitch, energy, speaking rate, or pause characteristics.

The term “face region” refers to a portion of image data corresponding to at least a part of a person's face, identified by applying a detection algorithm to the image data.

The term “body region” refers to a portion of image data corresponding to at least a part of a person's body excluding or in addition to the face, identified by applying a detection algorithm to the image data.

The term “facial feature information” refers to numerical or categorical data derived from the face region, including at least one of landmark positions, muscle movement indicators, expression intensity, or head pose parameters.

The term “posture feature information” refers to numerical or categorical data derived from the body region, including at least one of body orientation, limb positions, or overall posture classification.

The term “text information” refers to a sequence of characters or symbols representing the linguistic content recognized from the audio data by the speech recognition program. The term “acoustic feature information” refers to numerical values or vectors representing acoustic characteristics of the audio data, including at least one of pitch, loudness, spectral distribution, speech rate, or temporal patterns.

The term “evaluation element” refers to an individual aspect used for assessing a person, including at least one of answer content to a question, facial expression, body posture, appearance, speaking style, speech accent, operation behavior, working posture, or voice condition.

The term “feature vector” refers to an ordered set of numerical values representing one or more characteristics of the evaluation elements, constructed from at least facial feature information, posture feature information, acoustic feature information, and answer content. The term “prompt sentence” refers to a text sequence generated by the processor that includes at least one feature vector and an evaluation instruction, and that is provided as an input condition to a generative artificial intelligence model.

The term “evaluation instruction” refers to a directive contained in the prompt sentence that specifies a desired output of the generative artificial intelligence model, such as generation of element scores, integrated scores, or explanatory information.

The term “generative artificial intelligence model” refers to a machine learning model, such as a neural network, configured to generate outputs including at least element scores or integrated scores based on input feature vectors and prompt sentences.

The term “element score” refers to a quantitative value representing an assessment result for a corresponding evaluation element, generated by the generative artificial intelligence model or another scoring process.

The term “integrated score” refers to a quantitative value representing an aggregated assessment result obtained by combining a plurality of element scores according to a defined algorithm.

The term “weighting algorithm” refers to a numerical procedure, such as a weighted sum or other mathematical function, that applies weighting parameters to element scores to compute an integrated score.

The term “emotional state” refers to a categorized or parameterized condition of a user's affect, such as calmness, stress, fatigue, or concentration, inferred from scores or feature vectors.

The term “work efficiency” refers to an indicator of how effectively a worker performs a task, derived from evaluation elements or scores relating to performance.

The term “safety” refers to an indicator of a worker's risk level or compliance with safe working conditions, derived from evaluation elements or scores relating to behavior, posture, or stress.

The term “storage device” refers to a physical or logical data storage resource, such as a memory unit or a database system, configured to store time-series data including element scores and integrated scores.

The term “time-series data” refers to data records that include timestamps and corresponding values, such as sequential element scores and integrated scores recorded over time. The term “information display device” refers to an electronic apparatus, such as a client terminal or display system, configured to obtain processed data from the server and to present the data visually to a manager or other user.

The term “manager” refers to a person responsible for monitoring, evaluating, or guiding workers, who uses the information display device to review scores and determine actions. The term “user interface” refers to a software-controlled interaction mechanism, such as graphical controls or input fields, that allows a person to provide commands, adjust parameters, or view information in the system.

The term “weighting parameter” refers to a numerical coefficient associated with an evaluation element, used by the weighting algorithm to control the contribution of the element score to the integrated score.

The term “evaluation policy” refers to a set of rules or preferences defining how different evaluation elements should be prioritized or interpreted when calculating scores.

The term “machine learning model” refers to a trained computational model that maps input data to output values by using learned parameters, and that is used to score evaluation elements or to generate feature information.

The term “evaluation data set” refers to a collection of past data examples, including input features and associated labels or scores, used for training or validating the machine learning model.

The term “visualized and displayed” refers to the process by which numerical or textual data are converted into human-readable graphical or tabular representations on a screen of the information display device.

In one embodiment, a system includes a server, one or more terminals worn by workers, and one or more user devices operated by managers. The server, the terminal, and the user device cooperate to acquire multimodal sensor data, to convert the data into structured feature representations, to interact with a generative AI model using prompt sentences, and to generate and store element scores and integrated scores that are visualized for monitoring a worker's emotional state, work efficiency, and safety.

The terminal includes at least one imaging device, such as a miniature digital camera, at least one audio acquisition device, such as a microelectromechanical microphone, a local processor, a memory, and a wireless communication interface. The terminal may be implemented as smart glasses or another wearable computing device. The terminal executes an operating system, such as a mobile operating system, and application software that controls the imaging device and audio acquisition device.

The terminal uses the imaging device to capture frames of image data that include a face region and a body region of the worker. The terminal uses the audio acquisition device to capture audio data including the worker's voice. The terminal converts raw sensor outputs into digital streams, for example by encoding video using a compression codec and audio using pulse-code modulation. The terminal stores the digital streams in a circular buffer in local memory and transmits selected segments of the buffered streams to the server through a wireless network. By transmitting short, time-bounded segments, the terminal reduces communication load and limits latency.

The server is implemented as a computing platform that may include one or more general-purpose processors, one or more accelerators such as graphics processing units, volatile and non-volatile memories, and network interfaces. The server executes system software and application programs that perform image processing, speech recognition, acoustic analysis, feature vector construction, generative AI inference, scoring, data storage, and data provision to user devices.

The server receives image data and audio data from the terminal through a network-connected application program interface. The server stores the received data in a structured format, for example in files or blocks associated with a worker identifier, a session identifier, and timestamps. The server applies an image processing program to the image data. The image processing program may be implemented using a vision library such as a computer vision framework that provides face detection and body pose estimation algorithms. The server detects a face region by applying a convolution-based classifier or a cascade-based detector to each frame. The server detects a body region or keypoints by applying a pose estimation model that outputs coordinates of joints.

The server converts detected regions into facial feature information and posture feature information. The server, for example, calculates distances and angles between facial landmarks, such as corners of the mouth and eyes, and head pose parameters such as yaw and pitch, and stores these values in a facial feature vector. The server calculates joint angles, body orientation, and posture classification indicators (e.g., standing, bending, twisted posture) and stores these values in a posture feature vector. The server aggregates the per-frame values by computing statistics such as averages, variances, and temporal gradients over the relevant time interval.

The server applies a speech recognition program to the audio data. The speech recognition program may use an acoustic model and a language model to convert audio into text information. The server also applies an acoustic analysis program to the same audio data. The server computes acoustic feature information such as fundamental frequency, spectral centroid, energy over time, speaking rate, and pause durations. The server may use signal processing libraries to compute short-time Fourier transforms, mel-frequency coefficients, and other spectral descriptors. The server aggregates low-level acoustic features into higher-level descriptors that represent clarity, tone stability, and stress level.

The server combines the facial feature information, posture feature information, acoustic feature information, and text information representing answer content into a unified feature representation. The server normalizes each component by applying scaling functions such as z-score normalization or min-max normalization. The server then concatenates the normalized components into a feature vector for each evaluation element. For example, the server constructs a feature vector for an evaluation element “facial expression” by selecting and combining normalized facial features related to smile intensity, eye openness, and eyebrow movement. The server constructs a feature vector for an evaluation element “speaking style” by combining normalized acoustic features and text-based features.

The server constructs a prompt sentence that describes the evaluation task to a generative AI model. The server includes, in the prompt sentence, an indication of which feature vectors are being evaluated and what outputs are required. Example prompt sentences generated by the server include:
“Analyze the worker's facial expression features and audio features and generate a performance score (0-100) and a safety score (0-100), plus a short explanation of the main factors.”
“Using the input features ‘smile_intensity’, ‘concentration_level’, ‘fatigue_index’, ‘speech_clarity’, ‘tone_stability’, and ‘stress_level’, produce an overall productivity score and safety risk score for the current work segment.”
“Given this time-series of facial and vocal features, estimate whether the worker is in ‘normal’, ‘tired’, or ‘high-risk’ state, and output corresponding work efficiency and safety scores.”
“Analyze the worker's expression and voice and generate scores that evaluate work efficiency and safety, and provide a one-sentence recommendation for the manager's next action.”

The server uses the prompt sentence in combination with the feature vectors as inputs to a generative AI model. The generative AI model may be implemented as a neural network framework executing on the server. In one embodiment, the generative AI model includes an encoder that receives numerical feature vectors and embeds them into a latent representation, and a decoder that outputs element scores and integrated scores, and optionally textual explanations. The encoder may be a multilayer neural network having one or more fully connected layers with nonlinear activation functions such as rectified linear units. The decoder may be a set of output layers that produce numeric scores through activation functions and a text generation component implemented as a sequence model.

The server trains the generative AI model on historical data sets that include feature vectors, prompt sentences, and labeled outputs such as known element scores, integrated scores, and human-authored explanations. The server uses an error function such as mean squared error for numeric scores and cross-entropy for categorical outputs and tokens. The server updates network weights by using an optimization algorithm such as stochastic gradient descent or an adaptive method, and may use regularization techniques and data augmentation, for example by adding noise to feature vectors or altering temporal segmentation, to improve generalization.

The server may use another machine learning model as a preliminary scoring component. In such a case, the server inputs facial feature information, posture feature information, acoustic feature information, and text information to a supervised model that outputs preliminary element scores. The server then uses these preliminary scores as part of the input feature vectors to the generative AI model. By structuring the data flow in this way, the server separates low-level feature extraction, preliminary scoring, and generative integration, which improves modularity and allows reuse of components.

The server applies a weighting algorithm to the element scores generated by the generative AI model. The server stores a vector of weighting parameters in a configuration data structure. The server multiplies each element score by a corresponding weighting parameter and sums the weighted scores to produce the integrated score. The server may apply normalization or bounding operations to keep the integrated score within a specified range. The server may update weighting parameters in response to user input from the user device. The user device may be a workstation, a tablet, or another terminal with a display and input unit. The user uses a graphical user interface provided by the server to view time-series graphs, gauges, and tables that represent the integrated score and element scores. The user uses interface controls such as sliders or text boxes to adjust weighting parameters for evaluation elements. The server receives the new weighting parameters and stores them in the configuration data structure, so that subsequent integrated scores reflect the updated evaluation policy.

The server stores the element scores and integrated scores as time-series data in a storage device or a database. The server uses a data structure in which each record includes a worker identifier, a timestamp, element scores, the integrated score, and context metadata such as task type and position information. The server indexes the records so that the scores can be efficiently retrieved for a particular worker and time range. The server provides an application programming interface that allows the user device to request recent or historical scores, and the server transmits the structured data in response.

The user uses the displayed scores to recognize when a worker is exhibiting signs of fatigue, stress, or unsafe posture. However, the technical contribution of the system lies in the way in which the server processes the multimodal sensor data to generate the scores. By organizing the data into time-series feature vectors, by constructing prompt sentences that steer the generative AI model, and by performing weighted aggregation according to configurable parameters, the server improves the accuracy and robustness of automated evaluation compared to simple rule-based or single-modal systems.

The server improves processing speed and communication efficiency by having the terminal perform local buffering and by segmenting streams into fixed-length portions. The server reduces redundant computation by reusing extracted features for multiple evaluation elements and by caching intermediate representations. The server also reduces storage overhead by keeping raw image and audio segments only for a limited time while retaining compact feature vectors and scores for long-term analysis.

The server improves precision and reduces error by using a neural network architecture that explicitly models relationships between different evaluation elements. For example, the encoder in the generative AI model receives concatenated feature vectors and learns correlations between facial features indicative of fatigue and acoustic features indicative of stress. This joint modeling allows the server to distinguish between similar surface patterns that have different underlying meanings, which a purely manual or rule-based system cannot reliably achieve.

The server implements decision thresholds and confidence measures inside the scoring algorithm. The server, for example, calculates confidence scores based on the variance of the model outputs and may flag low-confidence evaluations. The server can thereby handle uncertain situations by requiring additional data or by avoiding overconfident assessments, which further distinguishes the system from human judgment or simplistic automation.

The system does not merely automate human evaluation but changes the nature of the processing. The generative AI model, directed by prompt sentences, applies learned, non-intuitive weighting and feature interactions that cannot be easily specified by human experts. The server executes a detailed, pre-defined pipeline that integrates low-level signal processing, high-dimensional feature representation, neural inference, and algorithmic aggregation, and this pipeline is specifically arranged to improve computing performance and data handling for this class of problems.

The server can be implemented in multiple configurations. In one variation, the image processing and acoustic analysis programs are executed partially on the terminal, and the terminal transmits pre-extracted features to the server, thereby reducing bandwidth requirements. In another variation, the generative AI model is deployed on a separate accelerator node, and the server communicates feature vectors and prompt sentences to that node over a high-speed internal network. In another variation, the user device directly subscribes to updates from a database that the server writes to, enabling near real-time visualization.

The terminal can also have alternative configurations. In some embodiments, the terminal includes additional sensors, such as inertial measurement units or physiological sensors, and the server extends the feature vectors to include motion or biometric features. In other embodiments, the terminal performs initial compression or aggregation of feature values before transmission, trading local computation for reduced network usage.

The user may employ the system in various domains. In one example, the user operates the system in a manufacturing plant to monitor workers on an assembly line. The terminal captures workers' faces and voices, the server processes the streams, and the user observes time-series safety scores and fatigue indicators. In another example, the user deploys the system in a training environment to evaluate trainees' engagement and stress, and adjusts training content based on the scores.

Because the server, the terminal, and the user device are configured as described above, the system provides a concrete, technical solution that improves computer-based evaluation of human states. The system achieves improved detection accuracy and reduced latency through integrated multimodal processing and optimized data flows, reduces communication and storage demands by using structured feature representations and segmented streaming, and enhances compute efficiency through modular learning architectures and reuse of intermediate features. These technical effects arise from the specific structure and operation of the server, terminal, and user device and are not merely the result of automating a human evaluation process.

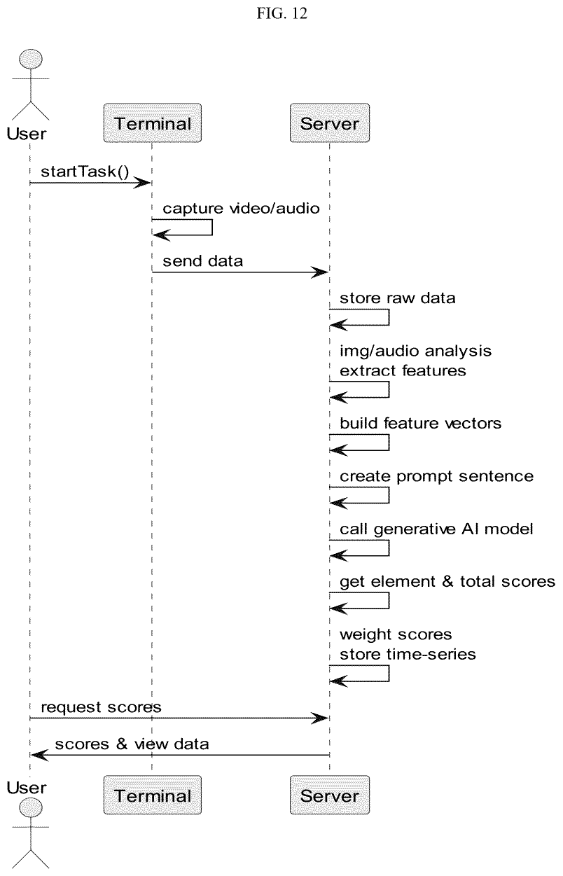

The following describes the processing flow using FIG. 12.

### Step 1:

The terminal activates an imaging device and an audio acquisition device and starts capturing time-series sensor data.

The input to this step is a control signal generated when a worker starts a task or when an application is launched on the terminal.

The terminal samples video frames from the imaging device at a predetermined frame rate and samples audio signals from the audio acquisition device at a predetermined sampling rate.

The terminal performs data processing by encoding the video frames into a compressed video stream and encoding the audio samples into a digital audio stream, associating timestamps and worker identifiers with each segment.

The output of this step is a set of synchronized video and audio segments with metadata, temporarily stored in a buffer in the terminal's memory.

### Step 2:

The terminal packages the buffered video and audio segments and transmits them to the server via a communication network.

The input to this step is the synchronized video and audio segments with timestamps and identifiers stored in the terminal buffer.

The terminal performs data processing by grouping the segments into packets, adding metadata fields such as device ID, session ID, and time range, and serializing the grouped data into a network message format.

The terminal then sends the network messages to a predefined server endpoint using a secure transport protocol.

The output of this step is one or more network messages containing encoded video, encoded audio, and associated metadata delivered to the server.

### Step 3:

The server receives the network messages from the terminal and stores the raw sensor data in a structured format.

The input to this step is the set of network messages carrying encoded video, encoded audio, and metadata.

The server performs data processing by parsing the messages, validating authentication tokens and message integrity, and extracting the video and audio payloads and metadata.

The server stores the extracted payloads in a storage structure, such as files or database entries, labeled with worker ID, session ID, and time interval.

The output of this step is a collection of stored raw image data and audio data segments, each associated with metadata and ready for further analysis.

### Step 4:

The server applies an image processing program to the stored image data to detect a face region and a body region of the worker.

The input to this step is an image data segment corresponding to a specific time interval.

The server performs data processing by decoding the compressed video stream into individual frames, running a face detection algorithm on each frame, and optionally running a body detection or pose estimation algorithm to identify body regions or keypoints.

The server computes coordinates and bounding boxes for the detected face region and body region in each frame.

The output of this step is a set of face region data and body region data, including spatial coordinates and frame indices.

### Step 5:

The server extracts facial feature information and posture feature information from the detected regions.

The input to this step is the face region data and body region data from each frame.

The server performs data processing by applying landmark detection models to the face region to obtain positions of eyes, eyebrows, nose, and mouth, and by computing geometric relationships such as distances and angles between landmarks.

The server calculates head pose parameters, such as yaw, pitch, and roll, and converts these measurements into numerical facial feature values, for example smile intensity and eye openness.

The server applies pose estimation to body keypoints and computes joint angles, torso orientation, and posture classification scores, converting them into numerical posture feature values.

The output of this step is a facial feature vector and a posture feature vector for the time interval, including aggregated statistics such as means and variances over all frames.

### Step 6:

The server applies a speech recognition program and an acoustic analysis program to the stored audio data.

The input to this step is an audio data segment aligned with the image data time interval.

The server performs data processing by normalizing the audio level, removing background noise, and segmenting the audio into analysis windows.

The server provides the processed audio to a speech recognition component to obtain text information representing recognized words and phrases, and simultaneously computes acoustic feature information such as fundamental frequency, energy envelope, spectral characteristics, speaking rate, and pause durations.

The output of this step is text information representing answer content or spoken content, and an acoustic feature vector summarizing prosodic and spectral properties of the audio.

### Step 7:

The server constructs feature vectors for a plurality of evaluation elements based on the extracted features.

The input to this step is the facial feature vector, the posture feature vector, the acoustic feature vector, and the text information.

The server performs data processing by normalizing each type of feature using predetermined scaling functions, and then selecting subsets of normalized features relevant to each evaluation element, such as facial expression, body posture, appearance, speaking style, accent, and answer content.

The server concatenates the selected normalized features for each evaluation element into a feature vector and associates each vector with an element label and a time interval.

The output of this step is a set of element-specific feature vectors representing the worker's state for the target time interval.

### Step 8:

The server generates a prompt sentence that describes an evaluation instruction for a generative AI model and binds it to the constructed feature vectors.

The input to this step is the set of element-specific feature vectors and configuration data that define which scores and explanations are requested.

The server performs data processing by formatting a natural language instruction that refers to the relevant features and required outputs.

For example, the server may generate text such as “Analyze the worker's facial expression features and audio features and generate a performance score (0-100) and a safety score (0-100), plus a short explanation of the main factors.”

The server embeds identifiers or summaries of the feature vectors in the prompt sentence or in associated structured fields, depending on the input interface of the generative AI model.

The output of this step is a prompt sentence and a corresponding set of feature vectors ready to be supplied to the generative AI model.

### Step 9:

The server invokes the generative AI model and obtains element scores and an integrated score.

The input to this step is the prompt sentence and the set of feature vectors for the evaluation elements.

The server performs data processing by encoding the feature vectors into numeric tensors and the prompt sentence into a tokenized sequence and feeding both into input layers of a neural network model.

The neural network executes a forward pass of an encoder-decoder architecture or equivalent structure, computing internal activations and producing numeric outputs corresponding to element scores and at least one integrated score.

The server decodes and post-processes the model outputs, constraining the scores to predetermined ranges and associating each score with the appropriate evaluation element and time interval.

The output of this step is a collection of element scores and at least one integrated score, optionally with generated explanatory text.

### Step 10:

The server applies a weighting algorithm to the element scores to refine or recompute the integrated score.

The input to this step is the collection of element scores from the generative AI model and the current set of weighting parameters stored in configuration data.

The server performs data processing by multiplying each element score by its corresponding weighting parameter, summing the weighted scores, and optionally normalizing the result.

The server may also compute confidence measures or threshold comparisons based on the distribution of element scores.

The output of this step is a final integrated score that reflects the configured weighting of elements and supplemental data such as confidence indicators.

### Step 11:

The server stores the element scores and integrated score as time-series data in a storage device.

The input to this step is the element scores, the integrated score, timestamps, worker identifiers, and context metadata.

The server performs data processing by constructing a data record containing all scores and metadata, indexing the record by worker ID and time, and inserting the record into a database or file-based storage structure.

The server may compress older raw sensor segments and retain compact feature vectors and scores to reduce storage usage.

The output of this step is an updated time-series database of scores that can be later retrieved and visualized.

### Step 12:

The user accesses the stored scores using a user device to visualize the worker's state and adjust evaluation settings if necessary.

The input to this step is a user request specifying a worker, a time range, and optional filter conditions, sent from the user device to the server.

The server performs data processing by querying the time-series database for records matching the request and returning structured score data to the user device.

The user device renders graphs, charts, and tables based on the received data, and the user interacts with controls to modify weighting parameters or selection of evaluation elements.

The output of this step is a visual representation of element scores and integrated scores on the user device and, if the user changes settings, updated weighting parameters sent back to the server for use in subsequent executions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented interview and evaluation systems typically rely on fixed scoring rules or static weighting schemes that are manually configured by system designers or human operators. In such systems, a processor often applies predetermined thresholds and coefficients to limited input signals, such as textual answers or simple numerical ratings, without flexibly adapting to different evaluation policies or contexts. As a result, these systems are constrained in their ability to provide nuanced, context-sensitive assessments of complex human characteristics, such as tone of voice, accent, facial expression, posture, and overall communication style.

Furthermore, in many existing implementations, multimodal data processing is fragmented. Speech recognition modules, image processing modules, and scoring logic are often integrated in an ad hoc manner, which can lead to inefficiencies in processing, inconsistent normalization of features, and difficulty in reconfiguring or scaling the system. The processor may need to perform repeated conversions or intermediate transformations that are not optimized, resulting in increased latency and resource consumption. This architecture reduces the practical usability of such systems in real-time or large-scale hiring and evaluation scenarios.

In addition, conventional systems typically require expert users to manually define weight parameters or scoring formulas using specialized configuration interfaces. This approach imposes a cognitive burden on users and limits the flexibility of non-expert users, such as hiring managers or interviewers, who wish to emphasize different evaluation elements (for example, tone versus accent) depending on a particular role or situation. The lack of a natural language interface for configuring evaluation criteria prevents intuitive and fine-grained control over system behavior.

Another limitation is that, even when machine learning models are used, they are often employed only to classify or score individual modalities, such as sentiment in text or simple facial emotion detection. They are not tightly integrated with a mechanism that automatically interprets user instructions expressed in natural language and translates those instructions into coherent, system-wide weighting information for multiple evaluation elements. Without such integration, the overall system cannot dynamically reconfigure its scoring pipeline end-to-end, which hinders adaptability and degrades the usefulness and reliability of the computed scores.

Moreover, many existing systems do not effectively exploit generative artificial intelligence models to parse and operationalize prompt sentences from users, nor do they provide a unified control flow in which a processor coordinates: (i) acquisition and feature extraction from multimodal candidate data, (ii) dynamic determination of per-element weight information based on natural language prompts, and (iii) computation of normalized, weighted, and aggregated scores suitable for objective comparison across candidates. This results in a technical deficiency in how computation is organized and controlled within the system, leading to suboptimal performance, scalability, and maintainability.

Accordingly, there is a need for an improved computer-implemented system and processing architecture in which a processor coordinates multimodal acquisition and analysis of response information, face information, body information, appearance information, voice expression information, and voice pronunciation information; in which a generative artificial intelligence model is used to automatically derive weighting information from natural language prompt sentences input by a user; and in which integrated, machine-learning-based speech recognition, image processing, and response analysis functions collectively produce standardized basic scores that are then weighted and aggregated into a comprehensive evaluation score. Such a system should reduce manual configuration effort, increase flexibility and expressiveness of evaluation policies, improve computational efficiency and consistency across modalities, and enhance the overall technical performance of the evaluation pipeline.

The specific processing by the specific processing unit 290 of the data processing device 12 in Example 2 is realized by the following means.

The present invention provides a server comprising a processor configured to acquire multimodal candidate information including response information to a question, face information of a person, body information of the person, appearance information of the person, voice expression information of the person, and voice pronunciation information of the person; to receive, via a terminal device, a prompt sentence in natural language input by a user, and to provide the prompt sentence to a generative artificial intelligence model so that the generative artificial intelligence model determines weighting information for respective evaluation elements corresponding to the multimodal candidate information; to acquire voice information of the person and to extract character information and acoustic feature information from the voice information by executing, under control of the processor, a program having a speech recognition processing function implemented by a machine learning model trained on evaluation-related data; to calculate, based on the character information and the acoustic feature information, basic scores for respective elements corresponding to the response information, the voice expression information, and the voice pronunciation information; to process the face information, the body information, and the appearance information by executing, under control of the processor, a program having an image processing function implemented by a machine learning model trained on evaluation-related data, and to calculate, based on results of the image processing, basic scores for respective elements corresponding to an expression state, a posture state, and an appearance state; to normalize the basic scores to a common score range and to apply weights to the normalized basic scores on the basis of the weighting information determined by the generative artificial intelligence model, thereby calculating, via a weighting algorithm, a comprehensive evaluation score and weighted element scores; to store and output the comprehensive evaluation score and the weighted element scores as evaluation results that are referable by the user; and to acquire an emotional state of the user and recognize the emotional state by executing, under control of the processor, a program having an emotion analysis function. This enables a technically improved evaluation infrastructure in which the processor orchestrates end-to-end multimodal data acquisition, machine-learning-based feature extraction, and generative-model-driven dynamic weighting in a unified computational pipeline, thereby reducing manual configuration overhead, allowing intuitive and fine-grained control of evaluation policies via natural language prompt sentences, improving consistency and efficiency of scoring across heterogeneous input modalities, and enhancing the reliability, scalability, and adaptability of computer-implemented hiring and assessment processes.

The term “system” refers to an arrangement including at least one computing device and associated components configured to execute programmed instructions to perform the claimed functions.

The term “server” refers to a computing device or computing environment that includes at least one processor and a memory, and that is configured to provide processing services or resources to one or more external devices over a communication network.

The term “processor” refers to one or more hardware processing units, such as a central processing unit or a graphics processing unit, configured to execute instructions stored in a memory to perform logical operations, arithmetic operations, control operations, and data transfer operations.

The term “terminal device” refers to an information processing device, such as a personal computer, a mobile device, or a tablet device, that includes at least one input interface and at least one output interface, and that enables a user to input information and to receive information from the server.

The term “user” refers to a human operator, such as an evaluator or hiring manager, who interacts with the system via the terminal device to configure evaluation conditions and to review evaluation results.

The term “person” refers to a human subject who is evaluated by the system based on multimodal information including speech, appearance, and behavioral features.

The term “response information” refers to information representing content of an answer provided by the person to a question, including text transcriptions derived from speech and any associated semantic or syntactic features.

The term “face information” refers to information relating to the appearance and movement of the person's facial region, including image data, video data, and extracted features such as facial landmarks and expression indicators.

The term “body information” refers to information relating to the pose, movement, and spatial arrangement of the person's body, including image data, video data, and extracted features such as body keypoints and posture indicators.

The term “appearance information” refers to information relating to visible attributes of the person's clothing, accessories, and overall outward style, including image data, video data, and extracted features such as formality, neatness, or color composition.

The term “voice information” refers to audio data representing sounds produced by the person, including speech waveforms and any derived acoustic features.

The term “voice expression information” refers to information relating to prosodic, paralinguistic, and expressive characteristics of the person's speech, including pitch, intonation, rhythm, loudness, and speaking rate.

The term “voice pronunciation information” refers to information relating to phonetic and articulatory characteristics of the person's speech, including accent, articulation clarity, and phoneme patterns.

The term “prompt sentence” refers to a sequence of words expressed in natural language and input by the user, which instructs the system how to configure or adjust evaluation behavior, including relative importance of different evaluation elements.

The term “natural language instruction” refers to a prompt sentence or a group of prompt sentences expressed in a human language and intended to specify evaluation preferences, constraints, or policies without requiring a formal configuration syntax.

The term “generative artificial intelligence model” refers to a data processing model implemented by machine learning techniques and trained on large data sets, which is configured to generate output data such as text or structured values in response to input data, including natural language prompt sentences.

The term “weighting information” refers to numerical values or parameters assigned to respective evaluation elements, which indicate relative importance or contribution of each evaluation element to a comprehensive evaluation score.

The term “evaluation element” refers to a category or dimension of assessment derived from multimodal information, such as response content, facial expression, posture, appearance, tone of voice, or pronunciation characteristics.

The term “basic score” refers to a numerical value representing an initial evaluation result for a particular evaluation element, calculated from extracted features before application of weighting information.

The term “element score” refers to a numerical value representing an evaluation result for a particular evaluation element after any normalization and weighting operations have been applied.

The term “comprehensive evaluation score” refers to a numerical value representing an overall assessment of the person, calculated by combining multiple element scores according to the weighting information and a weighting algorithm.

The term “weighting algorithm” refers to a computational procedure executed by the processor to combine basic scores or element scores with corresponding weighting information to generate weighted scores and a comprehensive evaluation score.

The term “speech recognition processing function” refers to a processing capability implemented by software and executed by the processor, which converts voice information into character information and may output acoustic feature information.

The term “image processing function” refers to a processing capability implemented by software and executed by the processor, which analyzes image data or video data to detect, track, classify, or quantify visual features related to a face, body, or appearance.

The term “analysis function for the response information” refers to a processing capability implemented by software and executed by the processor, which analyzes response information using natural language processing or statistical methods to assess relevance, coherence, correctness, or other quality measures.

The term “character information” refers to textual data produced by converting voice information into symbols or characters via a speech recognition processing function.

The term “acoustic feature information” refers to numerical or categorical values representing measurable properties of voice information, such as frequency characteristics, temporal characteristics, and spectral characteristics.

The term “expression state” refers to a classification or quantification of the person's facial expression, including indicators such as neutrality, positivity, negativity, or intensity of emotional display.

The term “posture state” refers to a classification or quantification of the person's body position and orientation, including indicators such as uprightness, slouching, or openness of posture.

The term “appearance state” refers to a classification or quantification of the person's clothing and outward style, including indicators such as formality, tidiness, or appropriateness.

The term “emotion analysis function” refers to a processing capability implemented by software and executed by the processor, which estimates an emotional state of the user based on input data such as interaction logs, biometric signals, or behavior patterns.

The term “emotional state” refers to a condition of affect or sentiment attributed to the user or the person, such as satisfaction, frustration, confidence, or anxiety, represented in a categorical or numerical form.

The term “machine learning model” refers to a computational model constructed by training on data sets using machine learning algorithms, which is configured to perform tasks such as classification, regression, recognition, or feature extraction.

The term “evaluation-related data” refers to data sets including labeled or unlabeled examples of multimodal information and associated evaluation outcomes, which are used to train or adapt machine learning models employed in the system.

The term “evaluation result” refers to data output by the system that includes at least one of element scores, a comprehensive evaluation score, or associated explanatory information, and that is provided for review or decision-making by the user.

In one embodiment, a server provides a multimodal evaluation system that cooperates with at least one terminal and at least one user. The server includes a processor, a main memory, a nonvolatile storage device, a network interface, and, optionally, one or more graphics processing units. The terminal includes an input interface, a display, a microphone, and, optionally, a camera. The user operates the terminal to configure evaluation conditions and to review evaluation results.

The server executes an operating system and an application program that together implement the claimed functions. The server uses general-purpose software components, such as a web server, an application execution environment, a relational database management system, and communication libraries. In one example, the server uses a web framework implemented in an interpreted programming language, a database engine for storing evaluation records, and a message queue for decoupling long-running processing tasks. The server further uses machine learning libraries such as a numerical computation framework and a deep learning library to perform speech recognition, image analysis, and scoring.

The server stores a generative AI model, a speech recognition model, an image analysis model, and an emotion analysis model. In one embodiment, the generative AI model is implemented as a transformer-based neural network comprising a plurality of attention layers and feed-forward layers, trained on large-scale text data. The generative AI model receives a prompt sentence in natural language and outputs structured weighting information for multiple evaluation elements. The speech recognition model is implemented as a neural encoder-decoder model that converts audio waveforms into symbol sequences and acoustic features. The image analysis model is implemented as a convolutional or hybrid convolutional-transformer network that detects a face region, a body region, and an appearance region, and outputs feature vectors corresponding to expression, posture, and appearance. The emotion analysis model is implemented as a neural classifier that maps input signals, such as text, audio, or interaction metadata, to an emotional state label or score. The user uses the terminal to access a user interface provided by the server. The terminal presents an input field for a natural language prompt sentence and buttons or other controls for starting and stopping recording. The user inputs a prompt sentence such as “Please evaluate with an emphasis on tone,” “Please evaluate with an emphasis on accent,” or “Please evaluate mainly based on tone and facial expression, and reduce the importance of clothing.”

The terminal transmits the prompt sentence to the server via a network using a structured message format. The prompt sentence is plain text and may include multiple clauses that refer to different evaluation elements.

The server receives the prompt sentence and generates an internal representation suitable for processing. The server converts the prompt sentence to a standardized character encoding, removes unnecessary whitespace, and segments the sentence into tokens. The server constructs an input context for the generative AI model, including a fixed-format instruction that specifies required output fields and ranges, and the tokenized prompt sentence. The server provides this context to the generative AI model.

The server causes the generative AI model to output a data structure representing weighting information. In one embodiment, the generative AI model outputs a vector of floating-point values corresponding to evaluation elements including response information, face information, body information, appearance information, voice expression information, and voice pronunciation information. The server validates that each value falls within a predetermined range and normalizes the vector so that a sum of weights or a norm of the vector satisfies a constraint. This normalization allows the server to apply a consistent weighting algorithm regardless of differences in individual prompt sentences.

The server stores the weighting information in association with an evaluation session identifier. The server uses a data structure such as a table in the database, where each record includes a session identifier, identifiers for evaluation elements, and corresponding weight values. The server may also store the original prompt sentence and a timestamp for auditability and later analysis. This explicit data structure improves reproducibility and facilitates later re-evaluation under modified conditions without reacquiring all multimodal data.

The terminal acquires multimodal data from the person to be evaluated. The terminal uses the microphone to record audio of the person's speech and optionally uses the camera to record video of the person's face and body. The terminal encodes the audio, for example into a waveform or compressed stream, and transmits the audio data to the server together with metadata including an identifier of the person, a session identifier, and question identifiers. When video is used, the terminal encodes the video and transmits it to the server in a similar manner.

The server stores the received audio and video data in a storage subsystem. The server assigns a unique identifier to each media object and records the identifier in a database table linked to the session identifier. The server may store a low-resolution proxy or extracted frames to reduce storage requirements for later analysis, while maintaining sufficient information to support the image processing function.

The server executes a speech recognition processing function on the stored audio data. In one embodiment, the server uses a neural network including an acoustic encoder, an attention mechanism, and a character-level or subword-level decoder. The server converts the audio waveform into a sequence of feature frames, such as mel-frequency cepstral coefficients or log-mel spectrograms, and feeds the feature frames to the encoder. The decoder outputs a character sequence representing the spoken content and also provides an intermediate representation, such as an embedding vector per frame, which the server uses as acoustic feature information. The server outputs both the recognized text and acoustic feature information. The recognized text becomes character information for use in response analysis; the acoustic feature information includes parameters such as pitch contours, energy distributions, speaking rate, and pause patterns, which are relevant for voice expression information and voice pronunciation information.

The server executes a response analysis function on the character information. The server uses a natural language processing model to compute semantic similarity between the recognized response and reference answers, assess grammatical correctness, and measure discourse coherence. In one embodiment, the server uses a transformer-based text encoder to map the response into an embedding vector and applies a linear or non-linear scoring layer that outputs a content-related score. This processing is not limited to simple keyword counting and provides robustness against paraphrasing and partial answers. The server stores intermediate features and intermediate scores in the database to support later inspection and potential retraining.

The server executes an image processing function on the video or still images. The server selects frames at periodic intervals or according to motion detection. For each selected frame, the server performs face detection and body keypoint detection using a convolutional or hybrid convolutional-transformer network trained on annotated human pose and expression data. The server extracts feature vectors that encode facial expression (for example, activation of facial muscles, presence of smiles or frowns), body posture (for example, degree of forward or backward leaning, openness of arms), and appearance (for example, presence of formal attire, overall neatness). The server then aggregates frame-level features over time using a temporal pooling function, such as average pooling or attention-based pooling, to obtain a single feature vector per evaluation element for the session.

The server converts the extracted features into basic scores. For each evaluation element, the server uses a trained machine learning model, such as a shallow neural network or a gradient-boosted decision tree, that maps the feature vector to a normalized score. For example, the server maps pitch variation and speaking rate features to a voice expression score and maps phoneme distribution and articulation clarity features to a voice pronunciation score. Similarly, the server maps facial action unit features to an expression state score and posture keypoint features to a posture state score. The server also maps color and texture descriptors, as well as shape features from the appearance region, to an appearance state score. Each model is trained with evaluation-related data that include human-labeled scores, using a loss function such as mean squared error for regression or cross-entropy for classification, and the server updates model parameters via gradient descent during the training phase. The server normalizes the basic scores across different models and modalities. In one embodiment, the server uses a calibration function that maps raw model outputs to scores in a common interval, such as 0 to 100, using parameters estimated from historical evaluation data. The server stores these normalized basic scores in a score table indexed by session identifier and evaluation element type. This normalization prevents one modality from dominating the comprehensive evaluation score simply due to scale differences in model outputs.

The server applies the weighting information to the basic scores. The server retrieves the weight vector corresponding to the current session and multiplies each normalized basic score by the corresponding weight. The server sums the weighted scores or computes a weighted average. Because the weights are generated by the generative AI model in response to the prompt sentence, the server can dynamically change how strongly different elements influence the comprehensive evaluation score without altering the underlying models or data acquisition process. The server stores the weighted scores and the comprehensive evaluation score in the database as part of the evaluation result.

The server uses this architecture to obtain technical advantages beyond mere automation of human evaluators. The server reduces computation by reusing shared representations between tasks: for example, the same acoustic encoder output supports both speech recognition and voice expression scoring, avoiding duplicate feature extraction. The server also reduces communication load between the terminal and the server because the terminal need not compute complex features; the terminal transmits primarily raw or lightly compressed media data, and the server performs centralized, optimized processing. The server improves scoring precision and stability by normalizing across sessions using historical statistics and by enforcing consistent weighting structures produced from natural language prompts. Because the generative AI model operates on a constrained instruction and outputs explicit numerical weights, the server can validate and bound the effect of user-specified policies, reducing variance and error relative to manual parameter entry.

The server achieves improved processing latency by decoupling prompt interpretation and media analysis. The server processes the prompt sentence asynchronously and stores the weighting configuration before or in parallel with media upload. The server uses a job queue and batch processing of audio and video, exploiting hardware acceleration on the server side. These implementation details allow the system to scale to many concurrent sessions without linear increases in response time. This technical improvement is not simply a human replacing manual weighting with numeric input; rather, the weighting algorithm and model-driven parsing of natural language prompts enable the processor to compute and apply structured weight vectors that are difficult for humans to manage consistently across many dimensions and sessions.

The terminal is responsible for interacting with the user and capturing high-quality input signals. The terminal manages local hardware resources, including microphones and cameras, to ensure that the media streams meet minimum sampling rate and resolution requirements. The terminal may pre-check network conditions and buffer media segments before transmission to reduce packet loss. By offloading heavy computation to the server, the terminal can operate on constrained hardware platforms, such as mobile devices, without sacrificing evaluation quality.

The user uses the terminal not only to configure evaluation emphasis but also to view detailed breakdowns of scores. The server generates data structures that separate base scores, weight values, and final weighted scores, and the terminal renders them in a format such as charts or tables. This separation allows the user to understand how the comprehensive evaluation score is derived and supports trust in the system. In some embodiments, the server also allows the user to adjust the prompt sentence and recompute weights and scores without reacquiring the underlying media, which supports rapid “what-if” analysis while minimizing additional data processing.

The server improves computer technology by introducing a specific data flow and control strategy that binds prompt sentences, generative AI output, and multimodal machine learning models into a unified pipeline. The server avoids generic “black box” behavior by enforcing explicit schemas for weight vectors and score structures, and by constraining the generative AI model to output only schema-compliant predictions. The use of shared feature encoders, temporal pooling, and calibrated scoring functions produces more accurate and consistent evaluations compared to independent, manually tuned modules. Because the server systematically maps natural language instructions to numerical parameters that control low-level scoring computations, and because the server orchestrates optimized feature extraction and model inference across heterogeneous modalities, the system improves processing efficiency, scalability, and reproducibility of complex multimodal evaluations. These improvements arise from the particular organization of data structures and algorithms inside the server and are not merely a computer implementation of a mental process.

Alternative embodiments are possible. The server may use different neural network architectures for the generative AI model, such as an encoder-decoder transformer with different layer depths, or may replace certain scoring models with non-neural models such as kernel-based regressors, as long as the server outputs normalized basic scores compatible with the weighting mechanism. The terminal may be a desktop computer, a thin client, a smartphone, or another network-enabled device with input and output capabilities. The user may provide different forms of prompt sentences, including multi-sentence instructions such as “For this role, prioritize accent clarity and content relevance, and treat posture as less important.” In all such variations, the server maintains the same fundamental behavior of deriving weighting information from natural language input, computing basic scores from multimodal data via trained models, and generating comprehensive evaluation scores using a structured weighting algorithm.

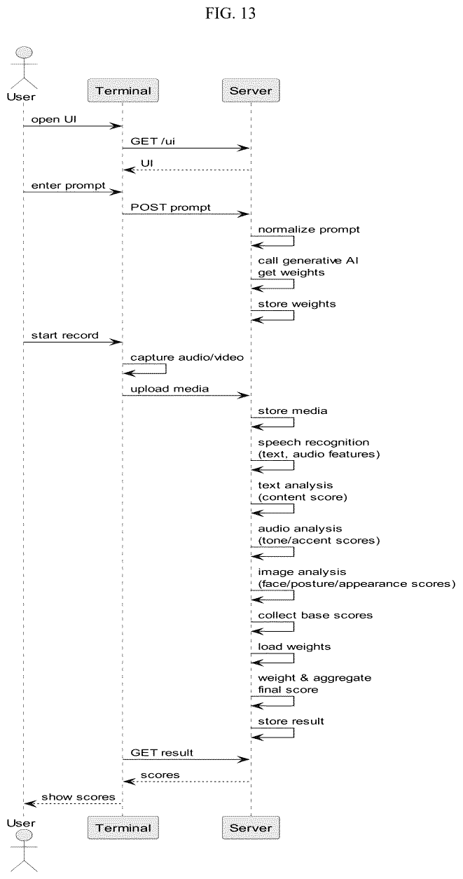

The following describes the processing flow using FIG. 13.

### Step 1:

The user operates the terminal to open an evaluation screen provided by the server. The terminal displays an input field for a prompt sentence and control buttons for recording. The input of this step is a user action (screen access), and the output is a rendered user interface on the terminal. The terminal receives configuration data (HTML, script, layout) from the server and renders it, thereby preparing interactive elements for later input and capture.

### Step 2:

The user inputs a prompt sentence on the terminal, for example “Please evaluate with an emphasis on tone.” or “Please evaluate with an emphasis on accent.” The input of this step is a natural language text entered by the user, and the output is a structured message including the prompt sentence and session metadata. The terminal validates that the text field is not empty, converts the text into a standardized character encoding, attaches a session identifier, and transmits the message to the server over a network connection.

### Step 3:

The server receives the prompt sentence from the terminal. The input of this step is the structured message including the prompt sentence and session identifier, and the output is a normalized text representation suitable for model input. The server parses the message, extracts the prompt sentence, converts full-width characters to half-width where necessary, trims whitespace, tokenizes the sentence, and stores both the raw and normalized prompt in a database table linked to the session identifier.

### Step 4:

The server prepares an input context for a generative AI model based on the normalized prompt sentence. The input of this step is the normalized prompt sentence, and the output is a model-ready request object. The server concatenates an instruction template (specifying required output fields and allowed ranges) with the normalized prompt sentence, encodes the combined text as tokens using the model's tokenizer, and constructs a data structure containing token IDs, attention masks, and other necessary parameters for subsequent inference.

### Step 5:

The server causes the generative AI model to calculate weighting information for evaluation elements. The input of this step is the model-ready request object (token IDs and context), and the output is a weight vector or structured set of numeric weights. The server executes the generative AI model on hardware (such as a CPU or GPU) so that the model processes the token sequence through multiple transformer layers, computes attention and feed-forward operations, and outputs a probability distribution or numeric values for each evaluation element. The server maps the model's raw outputs to floating-point weight values for elements including response content, facial expression, posture, appearance, voice expression, and voice pronunciation.

### Step 6:

The server normalizes and validates the weighting information produced by the generative AI model. The input of this step is the raw weight vector, and the output is a constrained, normalized weight vector stored in persistent storage. The server checks that all required evaluation elements are present, clamps any out-of-range values to predefined bounds, and normalizes the vector so that a sum or norm equals a predetermined constant. The server then writes the normalized weights, together with the session identifier and a timestamp, into a weight configuration table in the database.

### Step 7:

The user initiates recording on the terminal to capture voice, and optionally video, from a person to be evaluated. The input of this step is a user command (for example, pressing a record button), and the output is raw media streams stored temporarily on the terminal. The terminal activates the microphone, and optionally the camera, samples audio (and video) signals at defined rates (for example, 16 kHz for audio), buffers the data in memory, and displays a recording indicator on the screen.

### Step 8:

The terminal encodes and uploads the recorded media data to the server. The input of this step is raw or buffered media data (audio and optionally video) plus metadata (session ID, person ID), and the output is one or more network messages containing encoded media. The terminal compresses audio into a target format, segments the data into chunks if necessary, packages the audio and metadata in a suitable protocol format, and transmits the data to the server via a secure channel.

### Step 9:

The server receives and stores the media data in a storage subsystem. The input of this step is the encoded media stream or file and associated metadata, and the output is a stored media object with a unique identifier. The server reads the incoming data stream, assembles it into complete media files, assigns a unique media ID, writes the files to a file system or object store, and records the media ID, session ID, and person ID in a media table in the database.

### Step 10:

The server executes a speech recognition processing function on the stored audio data. The input of this step is an audio file reference (media ID and storage path), and the output is a transcript (character information) and acoustic feature information. The server loads the audio file, converts the waveform into feature frames such as log-mel spectrograms, feeds the frames into a neural speech recognition model, and obtains a sequence of recognized symbols alongside intermediate encoder representations. The server decodes the symbol sequence into text for response content and extracts acoustic features (for example, pitch contours, energy over time, and speaking rate) from the intermediate representations.

### Step 11:

The server analyzes the transcript to derive a content-related basic score. The input of this step is the recognized text (character information) and optional question metadata, and the output is a numeric score representing response quality. The server uses a natural language processing model to convert the text into an embedding vector, compares this vector with embeddings of reference answers or task descriptions, evaluates coherence and completeness, and calculates a scalar value (for example, between 0 and 100) reflecting content relevance and quality. The server stores both the embedding and the score in the database.

### Step 12:

The server analyzes the acoustic feature information to calculate basic scores for voice expression and voice pronunciation. The input of this step is the acoustic feature information, and the output is at least two basic scores: a voice expression score and a voice pronunciation score. The server computes statistical descriptors such as mean and variance of pitch, distribution of pause durations, and speech rate, and inputs these descriptors into trained regression or classification models. The models output normalized scores that reflect tone stability, expressiveness, accent clarity, and articulation quality, and the server stores these scores with their associated features.

### Step 13:

The server performs image processing on frames extracted from the video, if video is available. The input of this step is a video file reference and a set of timestamps or frame indices, and the output is visual feature vectors associated with face, body, and appearance. The server samples frames at regular intervals, detects the face and body regions using a trained detector, extracts keypoints and region-of-interest patches, and passes these to an image analysis network that outputs feature vectors describing facial expression, body posture, and clothing attributes.

### Step 14:

The server converts the visual feature vectors into basic scores for expression state, posture state, and appearance state. The input of this step is the visual feature vectors, and the output is a set of normalized basic scores for each visual evaluation element. The server aggregates frame-level features over time by averaging or applying an attention-based pooling, then passes the aggregated features to trained scoring models that output scalar values for facial expression, posture, and appearance. The server normalizes these values to a common range and stores them in the score table.

### Step 15:

The server collects all basic scores for the current session and prepares them for weighting. The input of this step is the set of basic scores for response content, voice expression, voice pronunciation, expression state, posture state, and appearance state, and the output is a consolidated score vector aligned with the weighting vector. The server queries the database for all scores linked to the session identifier, orders them according to a predefined mapping of evaluation elements, and constructs a vector of basic scores.

### Step 16:

The server retrieves the previously stored weighting information corresponding to the session. The input of this step is the session identifier, and the output is the normalized weight vector. The server performs a database lookup, loads the numerical weight values into memory, and verifies that the dimension of the weight vector matches the dimension of the consolidated score vector.

### Step 17:

The server applies the weights to the basic scores to calculate weighted element scores. The input of this step is the consolidated basic score vector and the normalized weight vector, and the output is a vector of weighted scores for each evaluation element. The server performs element-wise multiplication between the score vector and the weight vector, producing weighted scores that reflect the importance specified indirectly by the user's prompt sentence.

### Step 18:

The server aggregates the weighted element scores into a comprehensive evaluation score. The input of this step is the vector of weighted scores, and the output is a single scalar comprehensive evaluation score. The server sums the weighted scores or computes a weighted average, possibly applying a post-processing function such as scaling or clipping to maintain the score within a predetermined range. The server then stores the comprehensive evaluation score and the individual weighted scores in the evaluation result table.

### Step 19:

The server prepares an evaluation result object for presentation to the user. The input of this step is the stored comprehensive evaluation score, the basic scores, and the weighted scores, and the output is a structured response message. The server organizes the data into fields indicating per-element basic scores, weights, per-element weighted scores, and the overall score, and associates them with the person identifier and session identifier so that the terminal can display them coherently.

### Step 20:

The terminal requests and receives the evaluation result from the server. The input of this step is a user action or an automatic trigger to fetch results, and the output is a data payload containing scores and related information on the terminal. The terminal sends a query including the session identifier, receives the structured response from the server, parses the payload, and stores the parsed data temporarily in memory for rendering.

### Step 21:

The terminal displays the evaluation results to the user in a human-readable format. The input of this step is the parsed evaluation data structure, and the output is a graphical or textual representation on the terminal display. The terminal renders the comprehensive evaluation score as a numeric indicator and presents per-element scores, for example as bars or tables, so that the user can see how the prompt sentence (such as “Please evaluate with an emphasis on tone.”) influenced the weighting of each evaluation element.

### Step 22:

The server optionally analyzes user interaction to recognize an emotional state of the user. The input of this step is user-related data such as navigation patterns, feedback text, or secondary audio, and the output is an estimated emotional state label or value. The server extracts features from the interaction data and applies an emotion analysis model that outputs a classification or score representing the user's emotional state (for example, satisfaction or frustration), and the server stores this state for potential use in adjusting future user interface behavior or system responses.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional interview evaluation systems and human-machine interaction analysis systems suffer from several technical limitations in how they process and integrate multimodal data using computing resources. First, many existing systems treat audio, video, and textual data in isolated pipelines, or focus only on one modality such as text. As a result, the systems fail to generate a unified feature representation that fully exploits correlations between linguistic, acoustic, and visual signals, thereby limiting the accuracy and robustness of computed scores. Second, when a generative AI model is used, it is typically invoked in an ad hoc manner with manually crafted prompts that are not systematically derived from low-level features or from explicit evaluation policies. This leads to inconsistent outputs, unpredictable score ranges, and difficulty in controlling or reproducing the behavior of the generative AI model within a large-scale computing environment.

Third, many scoring architectures rely exclusively on either conventional machine learning models or on generative AI models, and do not provide a coordinated fusion of their outputs.

Consequently, the computational pipeline cannot leverage the strengths of both approaches—such as the structured, data-driven predictions of a trained machine learning model and the reasoning and explanation capabilities of a generative AI model—and often exhibits suboptimal performance, poor interpretability, or unstable behavior under varying input conditions. Fourth, emotion recognition, if present at all, is frequently implemented as a separate, loosely coupled component that is not integrated into the weighting and scoring logic. Therefore, conventional systems cannot dynamically adapt weighting parameters or evaluation policies in response to changes in emotional states inferred from multimodal input, which limits the system's ability to adjust its computation to context and user state. Fifth, prior systems usually expose only static configuration options to end users, and do not provide a consistent mechanism to propagate user-defined evaluation conditions—such as evaluation viewpoints, output formats, and score ranges—throughout the entire processing pipeline, including prompt generation for the generative AI model and numerical aggregation of scores. This prevents the computing system from flexibly and programmatically reconfiguring evaluation logic without complex redeployment or code modification. Sixth, the training of machine learning models and emotion estimation models is often performed externally or manually, without a unified data acquisition and preprocessing pipeline integrated into the production server. As a result, it is difficult to maintain model quality over time, and computational resources are not efficiently used to retrain or select models based on large, heterogeneous historical datasets.

Accordingly, there is a need for an improved computer-implemented system that: (i) acquires heterogeneous multimodal input and extracts unified feature information using coordinated natural language processing, acoustic signal processing, and image processing; (ii) automatically constructs prompt sentences for a generative AI model based on structured summary information and explicit evaluation policies; (iii) fuses scores from conventional machine learning models and the generative AI model into integrated element-level scores and a comprehensive score; (iv) computes emotion scores using an emotion engine and uses such emotion scores to dynamically adapt weighting parameters; and (v) allows a user to declaratively configure evaluation conditions, with those conditions being consistently reflected in both generative-AI-based processing and numerical aggregation. By implementing such an architecture, the computing system can improve technical performance in terms of scoring accuracy, stability, controllability, and explainability, thereby constituting an improvement to computer technology itself rather than a mere automation of human judgment.

The specific processing by the specific processing unit 290 of the data processing device 12 in Application Example 2 is realized by the following means.

The present invention provides a server comprising a processor configured to acquire heterogeneous input information including response information to questions, audio information, and image information from at least one terminal device; to extract linguistic feature information from the response information by using a natural language processing unit, to extract acoustic feature information from the audio information by using an acoustic signal processing unit, and to extract facial expression feature information and posture feature information from the image information by using an image processing unit so as to generate integrated feature information; to generate, for each evaluation element, summary information of characteristics from the integrated feature information, to construct a prompt sentence including the summary information and evaluation policy information, and to input the prompt sentence into a generative artificial intelligence model to obtain, from the generative artificial intelligence model, element-specific scores corresponding to the evaluation elements and explanation information; to input the integrated feature information into a machine learning model learned on the basis of a past evaluation data set, to generate, from the machine learning model, machine learning scores corresponding to the evaluation elements, and to integrate the machine learning scores with the element-specific scores obtained from the generative artificial intelligence model to calculate integrated scores for the respective evaluation elements; to operate an emotion engine including an emotion estimation model on the basis of the acoustic feature information, the image feature information, and the linguistic feature information, and to generate an emotion score indicating an emotional state of an evaluated subject or an evaluating subject; to apply, by using a numerical computation unit, a weighting algorithm to the integrated scores for the respective evaluation elements and the emotion score in accordance with weighting parameters set by a user, to calculate a comprehensive evaluation score, and to dynamically correct the weighting parameters in accordance with the emotion score; and to generate evaluation result information including the comprehensive evaluation score, the integrated scores for the respective evaluation elements, and the explanation information, to transmit the evaluation result information to the at least one terminal device, and to store the evaluation result information in a storage unit. This enables a coordinated, computer-implemented scoring architecture in which multimodal features are unified at the server level, prompt sentences for the generative AI model are automatically synthesized from structured summary information and explicit evaluation policies, outputs of the generative AI model and conventional machine learning models are fused into stable integrated scores, emotion-aware dynamic weighting is applied through numerical computation, and user-defined evaluation conditions are consistently propagated through both AI-based inference and numerical aggregation, thereby improving the technical performance, controllability, and efficiency of the underlying information processing system.

The term “heterogeneous input information” refers to input data that includes at least response information, audio information, and image information, and that originates from different sensing modalities or data sources.

The term “response information” refers to information representing content of answers or reactions to one or more questions, including textual input, transcribed speech, or structured answer data.

The term “audio information” refers to digital data representing sound captured from a subject, including voice signals used for speech recognition, tone analysis, and acoustic feature extraction.

The term “image information” refers to digital data representing visual scenes captured by an image sensing device, including still images or video frames that depict at least a subject's face, body, or surrounding environment.

The term “natural language processing unit” refers to a software or hardware component configured to perform computational linguistic analysis of text, including tokenization, part-of-speech tagging, syntactic parsing, semantic analysis, or sentiment analysis.

The term “linguistic feature information” refers to data representing one or more characteristics derived from text, such as word usage patterns, syntactic structures, semantic categories, sentiment indicators, or style indicators.

The term “acoustic signal processing unit” refers to a software or hardware component configured to analyze audio signals, including operations such as filtering, feature extraction, spectral analysis, or temporal analysis.

The term “acoustic feature information” refers to data representing one or more characteristics derived from audio signals, such as pitch, loudness, spectrum, speaking rate, prosody, or other quantitative acoustic descriptors.

The term “image processing unit” refers to a software or hardware component configured to analyze image information, including operations such as object detection, region extraction, feature extraction, tracking, or pattern recognition.

The term “facial expression feature information” refers to data representing characteristics of a subject's facial expression, such as positions of facial landmarks, inferred emotion categories, or numerical scores for expression intensity.

The term “posture feature information” refers to data representing characteristics of a subject's body orientation or pose, such as body alignment, limb positions, or indicators of openness, confidence, or tension.

The term “integrated feature information” refers to a combined data representation that aggregates linguistic feature information, acoustic feature information, image-derived feature information, or other feature information into a unified feature vector or structured data object.

The term “evaluation element” refers to a particular aspect or dimension of assessment, such as communication ability, professionalism, tone, accent clarity, facial expression positivity, posture appropriateness, or other defined evaluation criteria.

The term “summary information of characteristics” refers to a compact representation derived from feature information for each evaluation element, including descriptive text, statistical values, or encoded indicators suitable for use in a prompt sentence.

The term “evaluation policy information” refers to configuration information that indicates evaluation viewpoints, relative importance of evaluation elements, desired output format, score ranges, or other policies controlling evaluation behavior.

The term “prompt sentence” refers to a text sequence provided as input to a generative artificial intelligence model, the text sequence including instructions, context, and summary information that specify how the model should analyze data or generate scores and explanations.

The term “generative artificial intelligence model” refers to a trained computational model configured to generate text or other data in response to input prompts, the model being capable of reasoning over provided context and producing element-specific scores or explanations.

The term “element-specific score” refers to a numerical value associated with a particular evaluation element, the numerical value being generated by a model such as the generative artificial intelligence model or a machine learning model.

The term “explanation information” refers to text or structured data describing reasons, rationales, or interpretations associated with scores or evaluation results produced by the generative artificial intelligence model or other processing components.

The term “machine learning model” refers to a statistical or computational model that has been trained on a data set using one or more learning algorithms to predict or estimate outputs such as scores from input feature information.

The term “machine learning score” refers to a numerical value output by a machine learning model, the numerical value corresponding to a predicted evaluation value for a particular evaluation element.

The term “integrated score for an evaluation element” refers to a numerical value obtained by combining at least a machine learning score and an element-specific score from the generative artificial intelligence model for the same evaluation element.

The term “emotion engine” refers to a software or hardware subsystem that includes at least one emotion estimation model and is configured to infer an emotional state from one or more types of feature information.

The term “emotion estimation model” refers to a trained computational model configured to receive feature information such as acoustic feature information, image feature information, or linguistic feature information and to output an estimate of an emotional state.

The term “emotion score” refers to a numerical value indicating an estimated emotional state of an evaluated subject or an evaluating subject, such as positivity, anxiety, stress level, or engagement.

The term “weighting algorithm” refers to a computational procedure that applies weighting parameters to one or more scores and calculates a combined value, such as a weighted sum or weighted average.

The term “weighting parameter” refers to a numerical coefficient that represents the relative importance of a particular evaluation element or score when calculating a combined or comprehensive score.

The term “numerical computation unit” refers to a software or hardware component configured to execute arithmetic and numerical operations, including multiplication, addition, normalization, or other calculations used in the weighting algorithm.

The term “comprehensive evaluation score” refers to a numerical value representing an overall assessment result, the numerical value being calculated by applying the weighting algorithm to integrated scores for respective evaluation elements and optionally to at least one emotion score.

The term “dynamic correction of weighting parameters” refers to processing in which one or more weighting parameters are automatically adjusted during operation in response to data such as emotion scores, context information, or evaluation results.

The term “evaluation result information” refers to data including at least a comprehensive evaluation score, integrated scores for respective evaluation elements, and explanation information, and optionally including emotion scores or other metadata.

The term “terminal device” refers to an information processing device separate from the server, such as a client computer, portable communication device, or other user interface device, that transmits input information to the server and receives evaluation result information.

The term “user interface unit” refers to a software or hardware component that enables a user to input configuration information, weighting parameters, or evaluation conditions, and to view or otherwise access evaluation results.

The term “evaluation condition” refers to configuration data specifying at least evaluation viewpoints, output format, and score range, and controlling how evaluation processing and prompt generation are performed.

The term “model selection unit” refers to a software or hardware component configured to evaluate multiple candidate learning algorithms or hyperparameter settings and to select one or more trained models based on performance metrics.

The term “preprocessing unit” refers to a software or hardware component configured to perform operations such as missing-value completion, feature extraction, normalization, and data partitioning on raw historical data prior to model training.

The term “past evaluation data set” refers to stored data including historical responses, audio and image records, human ratings, or other annotations that are used to train or validate the machine learning model or the emotion estimation model.

The term “storage unit” refers to any memory or storage resource, such as a semiconductor memory, magnetic storage, or optical storage, configured to store models, feature information, evaluation result information, or configuration data.

In one embodiment, a server, a terminal, and a user cooperate to implement the claimed system. The server includes at least one processor, a memory, a network interface, and a storage unit. The terminal includes an input/output interface, a camera, a microphone, a display, and a communication interface. The user operates the terminal to initiate an evaluation session, provide configuration information, and review generated evaluation results.

The server executes programs stored in the memory to realize a plurality of functional units, including a data acquisition unit, a natural language processing unit, an acoustic signal processing unit, an image processing unit, a feature integration unit, a prompt generation unit, a generative AI model interface unit, a conventional machine learning inference unit, an emotion engine, a numerical computation unit, a model training unit, a user interface management unit, and a reporting unit. The server may be implemented on general-purpose computing hardware such as a multi-core processor system with a hardware accelerator for matrix operations, for example a graphics processing device or a tensor processing device. The terminal captures heterogeneous multimodal input using concrete hardware components. The terminal activates the camera to capture video frames including a face and body of an evaluated subject and activates the microphone to capture an audio stream including the subject's speech. The terminal converts these signals into digital image information and digital audio information, respectively, and transmits the information, together with metadata such as timestamps, session identifiers, and question identifiers, to the server via a network. The server receives the heterogeneous input information via the network interface. The server stores the raw audio and image information in the storage unit and registers metadata in a structured data schema, for example a table with fields for session identifier, question identifier, frame index, audio segment offset, and device identifier. The server associates textual response information with the corresponding audio and image segments. The response information may be typed on the terminal by the user, or may be obtained by speech recognition on the server.

The server performs speech recognition by invoking a speech-to-text software component. The server may use a cloud-based speech recognition service or an on-premise speech recognition library. The server resamples the audio information to a fixed sampling rate, normalizes amplitude, and segments the audio into utterance-level segments based on detected silence intervals. The server sends each segment to the speech recognition engine and receives a text transcript with word-level timestamps. The server stores the transcript as response information and later uses it for linguistic analysis and timing analysis. By standardizing audio format and segment boundaries before recognition, the server reduces recognition errors and improves the quality of downstream linguistic features. The server executes the natural language processing unit to derive linguistic feature information from the response information. The server loads a statistical or neural natural language processing model and applies tokenization, part-of-speech tagging, syntactic parsing, and semantic analysis. The server extracts explicit feature vectors that include counts of positive and negative sentiment words, frequency of hedging expressions, distribution of sentence lengths, occurrence of domain-specific technical terms, and indicators of politeness or formality. The server stores these features in a numerical matrix where each row corresponds to an utterance and each column corresponds to a defined linguistic feature dimension. This structured feature representation enables efficient batch processing and compatibility with conventional machine learning algorithms.

The server executes the acoustic signal processing unit to derive acoustic feature information. The server applies digital signal processing algorithms, such as framing and windowing of the audio signal, fast Fourier transforms, and computation of Mel-frequency cepstral coefficients. The server extracts pitch contours, energy profiles, spectral centroid, formant estimates, and speaking rate. The server normalizes features over time and packages them into a time-aligned matrix representation. The server may use an acoustic feature library to compute these descriptors. By employing a consistent acoustic feature set, the server improves robustness of emotion estimation and tone evaluation.

The server executes the image processing unit to derive facial expression feature information and posture feature information. The server decodes video frames into pixel arrays and uses a face detection algorithm, such as a convolutional neural network-based detector, to locate faces. The server applies a landmark detection model to obtain coordinates of eyes, eyebrows, nose, and mouth. The server computes expression features such as mouth curvature, eye openness, eyebrow raise, and head tilt. The server also performs human pose estimation, for example by using a keypoint detection neural network, to obtain positions of shoulders, arms, and torso. The server encodes posture features such as back straightness, arm crossing, and leaning direction into numeric values. These features are stored in a feature tensor indexed by time and body joint.

The server executes the feature integration unit to combine linguistic feature information, acoustic feature information, and image-derived feature information into integrated feature information. The server aligns features by their timestamps, interpolates or aggregates features to a common time grid, and concatenates vectors into a unified feature vector. The server may optionally apply dimensionality reduction, such as principal component analysis or an autoencoder network, to compress the integrated feature vector and reduce computation cost. This unified feature representation enables the server to exploit cross-modal correlations when computing scores and emotion estimates.

The server executes the emotion engine to calculate emotion scores. In one embodiment, the server uses a neural network that receives as input a concatenation of acoustic, visual, and linguistic features. The neural network may be a multi-branch architecture where each modality is processed by a separate sub-network. For example, the server may use a temporal convolutional network or recurrent network on acoustic features, a convolutional network on image-derived features, and a transformer or recurrent network on linguistic features. The outputs of the sub-networks are concatenated and passed through fully connected layers to generate one or more emotion scores, such as positivity, anxiety, stress level, or engagement, each in a normalized range. The server trains this network using supervised learning on historical data where human annotators provided emotion labels. The server uses a loss function such as mean squared error or cross-entropy, and gradient-based optimization with mini-batch updates to adjust network weights. The server may also use data augmentation, for example adding noise to audio or small geometric transformations to images, to improve generalization.

The server executes the machine learning inference unit to compute machine learning scores for evaluation elements. The server may use gradient boosted decision trees, random forests, or deep neural networks configured to output scores for communication ability, professionalism, technical skill, or other evaluation elements. The server inputs integrated feature information into these models and obtains per-element machine learning scores. To train such models, the server invokes the model training unit using past evaluation data sets containing feature vectors and associated human ratings. The server splits data into training and validation sets, optimizes hyperparameters through a model selection unit, and stores the selected trained model in the storage unit. This integrated training pipeline allows the server to continuously improve scoring accuracy as more labeled data become available.

The server generates prompt sentences for a generative AI model by using the prompt generation unit. The server converts integrated feature information into human-readable summary information, such as:
“The candidate spoke at an average rate of 150 words per minute with few pauses. The candidate's facial expression was mostly smiling, posture remained upright, and clothing was formal business attire. The linguistic analysis indicates frequent use of polite expressions and positive sentiment words.”

The server reads evaluation policy information and user-specified evaluation conditions, including evaluation viewpoints, desired output format, and score ranges. The server combines these data into a prompt sentence for the generative AI model. For example, the server may construct a prompt sentence as:
“Using the following description of the candidate's behavior and language, evaluate the candidate's communication ability and professionalism as scores from 0 to 100. Focus on tone, clarity, and appropriateness. Output plain text containing ‘communication score:’, ‘professionalism score:’, and a brief explanation. Description: [summary text].”

In another example, when tone and accent are emphasized, the server may construct a prompt sentence as:
“Based on the following interview transcript and behavior summary, evaluate whether the candidate's tone is bright and friendly and whether the candidate's accent is easy to understand. Assign a tone score (0-100) and an accent score (0-100), weighting tone at 70% and accent at 30%. Provide a short explanation of your assessment.”

The server transmits the prompt sentence to the generative AI model through the generative AI model interface unit. The generative AI model may reside on the same server or on a remote computing resource. The server sets parameters such as maximum output length and randomness. The generative AI model outputs text that includes scores and explanation information. The server parses the output using rule-based or pattern-based parsers to extract numeric element-specific scores and explanation strings. By using feature-based summaries and explicit prompt structure, the server ensures that the generative AI model operates in a constrained, predictable manner and that its outputs are directly mappable to internal data structures.

The server employs a numerical computation unit to integrate machine learning scores and generative AI-derived element-specific scores into integrated scores for evaluation elements. The server stores scores in vectors aligned by element, and applies numerical operations, such as weighted averaging or learned combination functions, to compute integrated scores. The server may assign confidence weights to each source, for example giving higher weight to the conventional model in well-represented regions of the feature space and higher weight to generative AI outputs in sparse regions. This hybrid integration improves overall scoring stability and accuracy by combining the strengths of structured statistical models and flexible generative reasoning.

The server uses the emotion score to dynamically adjust weighting parameters. For instance, when the emotion score indicates high anxiety, the server may automatically increase the weight assigned to tone and decrease the weight assigned to clothing. The server calculates adjusted weighting parameters by applying a deterministic rule or a learned mapping from emotion scores to weight adjustments. The server then applies a weighting algorithm to integrated scores and the emotion score to compute a comprehensive evaluation score. The server uses optimized linear algebra routines to perform matrix-vector multiplications for the weighting computation, improving processing speed and scaling to large numbers of evaluated subjects.

The server generates evaluation result information including the comprehensive evaluation score, integrated scores for evaluation elements, emotion scores, and explanation information provided by the generative AI model. The server formats this information in a structured way, such as a hierarchical data object, and passes it to the reporting unit. The reporting unit generates visual representations, such as bar charts and radar charts, and generates a human-readable report to be delivered to the terminal. The terminal displays the results on the display, allowing the user to view numeric scores, explanations, and historical comparisons. The user interacts with the user interface generated on the terminal to configure evaluation conditions. The user may adjust weighting parameters through sliders, input desired score ranges, or change evaluation viewpoints by selecting checkboxes. The terminal sends these settings to the server, which stores them in a configuration store and immediately applies them in prompt generation and numerical aggregation. The user may also request re-evaluation under different conditions without re-capturing data. The server can recompute prompts, call the generative AI model again, and recompute scores using the same integrated feature information. This architecture enables dynamic reconfiguration without re-training models, improving flexibility and computational efficiency.

In another embodiment, the server executes a model training unit periodically or on demand to retrain the machine learning model and the emotion estimation model using freshly acquired historical data stored in the database. The server performs preprocessing by filling missing values, normalizing feature scales, and partitioning the data into training and validation subsets. The server runs a model selection algorithm that evaluates multiple model architectures and hyperparameter settings using performance metrics such as mean absolute error or F-score. The server stores the best-performing models, replacing older versions. This continuous training process improves long-term accuracy and adapts to changes in data distributions.

The described architecture provides technical effects beyond mere automation of human judgment. The server unifies heterogeneous multimodal features into an integrated feature information structure, which allows downstream models to leverage cross-modal correlations that cannot be effectively exploited by human evaluators or traditional siloed pipelines. The server automatically synthesizes structured prompt sentences from feature summaries and evaluation policies, resulting in consistent and reproducible interaction with generative AI models, and reducing unpredictability and variance in AI outputs. By combining conventional machine learning scores with generative AI-derived scores using optimized numerical routines and emotion-dependent dynamic weighting, the server achieves improved scoring precision and robustness while reducing the need for manual rule tuning. Furthermore, the server implements specific data structures, time-aligned feature matrices, and modular neural network architectures that are trained with defined loss functions and optimization methods, thereby improving computational efficiency and scalability. The server can process multiple interview sessions in parallel, using batch feature extraction and batched calls to inference engines, leading to reduced processing time per subject and lower resource usage. Because the system relies on explicit feature extraction and integrated scoring logic, it can provide detailed diagnostics and explanations that are not attainable with manual evaluation or with naive applications of generative AI.

The system is applicable to real-world technical use cases such as automated evaluation of candidates in remote video interviews, monitoring of worker stress states via on-site cameras and microphones, and real-time feedback to customer service personnel using wearable terminals. In each case, the server does not merely implement a business rule workflow but instead performs specialized signal processing, feature extraction, neural inference, and numerical optimization procedures that improve the operation of the computing system itself, including reduced communication overhead through compact feature representations, improved data management through standardized schemas, and enhanced computational throughput through optimized vectorized operations and hardware acceleration.

Alternative embodiments may vary the architectures and algorithms while preserving the essential configuration. The server may use different natural language processing frameworks or different neural architectures, such as transformers for text and temporal convolutional networks for audio, as long as linguistic and acoustic features are extracted and integrated. The emotion engine may be implemented as a probabilistic graphical model instead of a neural network, and the weighting algorithm may be learned via regression instead of being predefined. The generative AI model may be replaced with another generative model capable of processing prompt sentences and generating scores and explanations. The terminal may be a desktop computer, smartphone, tablet, or head-mounted display, as long as it can capture multimodal input and present evaluation results.

In this way, the server, the terminal, and the user implement a technically concrete system in which multimodal sensing hardware, signal processing software, machine learning models, and generative AI models are combined through defined data structures and algorithms to achieve improved evaluation accuracy, computational efficiency, and controllability in a manner that constitutes an improvement to computer technology.

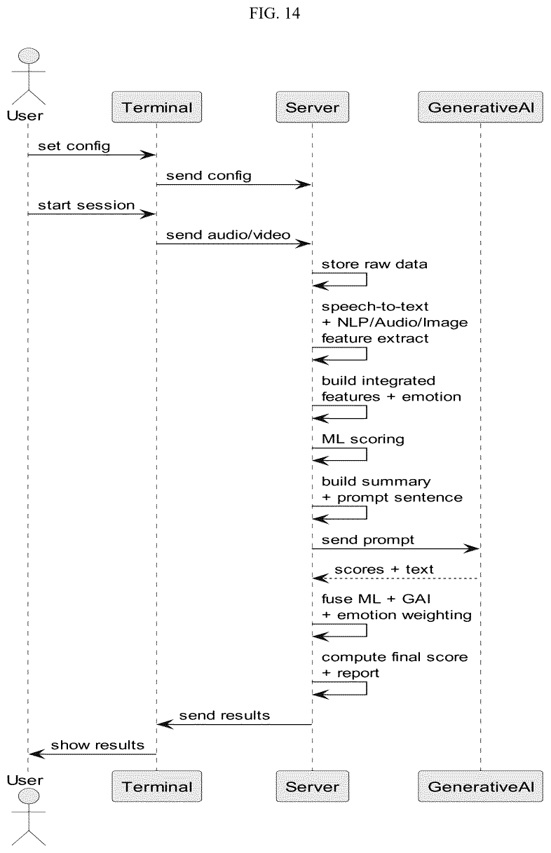

The following describes the processing flow using FIG. 14.

### Step 1:

User configures evaluation conditions and weighting parameters.

User operates the terminal to open a configuration screen and selects evaluation elements (for example, communication ability, professionalism, tone, accent, expression, posture).

User adjusts sliders or checkboxes to set weighting parameters (for example, tone 0.7, accent 0.3) and specifies evaluation conditions such as score range (0-100), output format (scores plus explanation), and evaluation viewpoints (for example, “focus on politeness and clarity”).

Input: user's configuration operations on the terminal GUI.

Output: a configuration object containing evaluation elements, weighting parameters, score ranges, and evaluation viewpoints.

User confirms the configuration by pressing a “Start evaluation” button, and the terminal sends the configuration object to the server via an API request.

### Step 2:

Terminal captures multimodal input data.

Terminal activates the camera to capture video frames of the evaluated subject at a fixed frame rate and activates the microphone to capture audio of the subject's speech.

Terminal associates each video frame and audio chunk with timestamps, a session identifier, and a question identifier obtained from the UI state.

Input: physical light and sound signals from the evaluated subject.

Output: digitized image information (for example, compressed video frames) and digitized audio information (for example, PCM or encoded audio stream) with associated metadata. Terminal transmits batches of image and audio data, along with any text typed by the user (for example, typed answers or interviewer notes), to the server over a secure network connection.

### Step 3:

Server receives and stores raw multimodal data.

Server listens on a network interface and accepts incoming connections from the terminal, then decodes received messages into image information, audio information, and response information.

Server assigns or verifies session identifiers and question identifiers, and writes the raw data and metadata into a structured storage format, such as records in a database and binary objects in a storage unit.

Input: image information, audio information, and response information transmitted from the terminal, plus the configuration object from Step 1.

Output: stored raw multimodal records linked by session and question identifiers, ready for analysis; an in-memory session context containing evaluation conditions.

### Step 4:

Server performs speech recognition and obtains textual response information.

Server preprocesses the audio information by resampling to a fixed sampling rate, normalizing amplitude, and segmenting the audio stream into utterance segments based on silence detection.

Server sends each audio segment to a speech recognition engine and receives an associated text transcript with word-level timestamps.

Input: preprocessed audio segments with timestamps.

Output: textual response information (transcripts) and timing data (word boundaries and utterance start/end times).

Server stores the textual response information alongside the corresponding audio segments in the database and marks it as available for linguistic analysis and timing analysis.

### Step 5:

Server extracts linguistic feature information.

Server passes each textual response to a natural language processing unit that performs tokenization, part-of-speech tagging, syntactic parsing, and sentiment analysis by invoking a language model.

Server computes features such as counts of positive and negative sentiment words, frequency of hedging expressions, average sentence length, proportion of polite expressions, presence of domain-specific terms, and syntactic complexity metrics.

Input: textual response information and, optionally, question context.

Output: linguistic feature vectors, each element representing a quantitative linguistic characteristic (for example, sentiment score, technical term ratio).

Server normalizes features, for example by scaling them to zero mean and unit variance, and stores them in a feature table indexed by session and question identifiers.

### Step 6:

Server extracts acoustic feature information.

Server segments the audio signal into frames, applies windowing, and computes spectral representations such as Mel-frequency cepstral coefficients, energy, and spectral centroid.

Server calculates pitch contours, speaking rate (words per minute), and prosodic features such as intonation variation and pause distribution.

Input: audio segments and associated timing data from Step 4.

Output: acoustic feature vectors, each element representing a quantitative acoustic characteristic (for example, mean pitch, variance of loudness, speaking rate).

Server aggregates frame-level features over utterances (for example, by computing means and variances) and stores the aggregated feature vectors in a numerical matrix.

### Step 7:

Server extracts facial expression and posture feature information.

Server decodes each video frame and uses an image processing unit to detect faces and body keypoints.

Server applies a facial landmark detection model to determine positions of eyes, eyebrows, nose, and mouth, and computes expression measures such as smile intensity, eye openness, and eyebrow raise.

Server performs pose estimation to determine positions of shoulders, arms, and torso, and computes posture measures such as back straightness, head tilt, and arm crossing.

Input: image information and associated timestamps from Step 3.

Output: facial expression feature vectors and posture feature vectors, each element representing a numeric measure (for example, smile intensity, torso angle).

Server aligns these features to the utterance times using timestamps and stores them in a time-aligned feature structure.

### Step 8:

Server constructs integrated feature information.

Server aligns linguistic, acoustic, and visual features by timestamps or question identifiers and concatenates them into a unified feature vector for each evaluation interval or question. Server optionally applies dimensionality reduction or feature selection to remove redundant or low-variance features, using methods such as principal component analysis or feature importance scores from a trained model.

Input: linguistic feature vectors from Step 5, acoustic feature vectors from Step 6, and expression and posture feature vectors from Step 7.

Output: integrated feature vectors, each representing a combined multimodal description of the evaluated subject's behavior for a given interval or question.

Server stores integrated feature vectors in a structured data store for use by the emotion engine, machine learning models, and prompt generation unit.

### Step 9:

Server computes emotion scores with an emotion engine.

Server feeds integrated feature vectors into an emotion estimation model implemented as a neural network or another predictive model.

Server propagates the feature vectors through modality-specific sub-layers and shared layers to obtain outputs representing estimated emotional states (for example, positivity, anxiety, stress level, engagement).

Input: integrated feature vectors from Step 8.

Output: emotion scores for each evaluation interval, expressed as numeric values within a defined range (for example, 0-1 or 0-100).

Server associates emotion scores with the corresponding session and question identifiers and stores them in an emotion score table.

### Step 10:

Server calculates machine learning scores for evaluation elements.

Server inputs integrated feature vectors into at least one conventional machine learning model, such as a trained classifier or regressor, that has been learned on a past evaluation data set.

Server obtains predicted scores for each evaluation element, for example communication ability, technical skill, or professionalism, as continuous values or probabilities.

Input: integrated feature vectors from Step 8 and a trained machine learning model stored in the storage unit.

Output: machine learning scores for each evaluation element, represented as numeric vectors.

Server rescales raw outputs to a standard score range (for example, 0-100) and writes them into a per-session score table.

### Step 11:

Server generates summary information and a prompt sentence for the generative AI model.

Server converts integrated feature vectors and emotion scores into descriptive text that summarizes the evaluated subject's behavior, for example:
“The candidate spoke at an average rate of 150 words per minute with few pauses. The candidate's facial expression was mostly smiling, posture was upright, and clothing appeared formal. Linguistic analysis shows frequent polite expressions and overall positive sentiment.” Server reads the evaluation policy and weighting parameters from the configuration object and composes a prompt sentence that instructs the generative AI model how to evaluate and output scores.

Input: integrated feature vectors, emotion scores, evaluation conditions, and configured evaluation elements.

Output: a prompt sentence containing descriptive text, requested score types, score ranges, and output format instructions.

Server may, for example, generate a prompt sentence such as:
“Using the following description of the candidate's behavior and language, evaluate the candidate's communication ability and professionalism as scores from 0 to 100. Focus on tone, clarity, and appropriateness. Provide text in the form: ‘communication score: [value]’, ‘professionalism score: [value]’, followed by a brief explanation. Description: [summary text].”

### Step 12:

Server calls the generative AI model and obtains element-specific scores and explanation information.

Server sends the constructed prompt sentence to a generative AI model interface and requests a completion with controlled parameters such as maximum response length and temperature. Server receives the generative AI model's output text and parses it to extract numeric values and explanation strings according to expected patterns (for example, locating “communication score:” and reading the following numeric token).

Input: prompt sentence from Step 11 and model configuration settings.

Output: element-specific scores for requested evaluation elements and explanation information (for example, free-form textual reasoning about the scores).

Server standardizes the extracted scores into the same scale as machine learning scores and stores them in a generative-AI score table.

### Step 13:

Server integrates machine learning scores and generative-AI scores for each evaluation element.

Server retrieves machine learning scores and generative-AI element-specific scores for the same evaluation elements and combines them using a defined integration rule, for example a weighted average or confidence-based fusion.

Server computes, for each evaluation element, an integrated score that reflects contributions from both conventional models and the generative AI model.

Input: machine learning scores from Step 10 and element-specific scores from Step 12.

Output: integrated scores for evaluation elements, represented as a vector aligned with the configured evaluation elements.

Server records integrated scores in a consolidated score structure for further processing.

### Step 14:

Server applies emotion-aware weighting and calculates a comprehensive evaluation score.

Server retrieves the weighting parameters configured by the user and adjusts them dynamically based on emotion scores. For example, the server may increase the weight on tone and communication ability when anxiety scores exceed a threshold.

Server multiplies integrated scores by the adjusted weighting parameters and optionally incorporates the emotion score as an additional weighted term. The server then sums these products to compute a single comprehensive evaluation score.

Input: integrated scores for evaluation elements from Step 13, emotion scores from Step 9, and user-configured weighting parameters from Step 1.

Output: a comprehensive evaluation score representing the overall evaluation result for the session or subject.

Server normalizes the comprehensive evaluation score to the configured range (for example, 0-100) and stores it in the result table.

### Step 15:

Server generates evaluation result information and sends it to the terminal.

Server composes an evaluation result object containing the comprehensive evaluation score, integrated element-level scores, emotion scores, and explanation information from the generative AI model.

Server optionally generates a human-readable report, including charts and textual summaries, using the evaluation result object.

Input: comprehensive evaluation score, integrated scores, emotion scores, and explanation information.

Output: evaluation result information ready for presentation, formatted as a structured object or document.

Server transmits the evaluation result information to the terminal over the network.

### Step 16:

Terminal presents evaluation results and user reviews them.

Terminal receives the evaluation result information, parses it, and updates the display to show element-level scores, the comprehensive evaluation score, and key explanation text.

Terminal may render graphs, color indicators, or tables to make the output easier to interpret.

Input: evaluation result information from Step 15.

Output: visual and textual presentation of evaluation results on the terminal display.

User views the evaluation results, optionally adjusts evaluation conditions or weighting parameters for a new run, and may store or export the report for later use.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

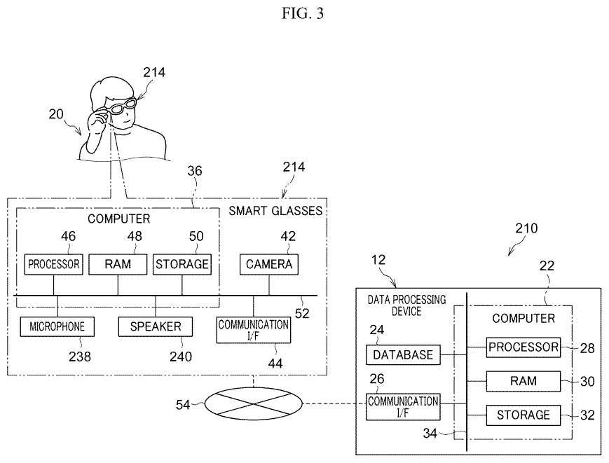

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

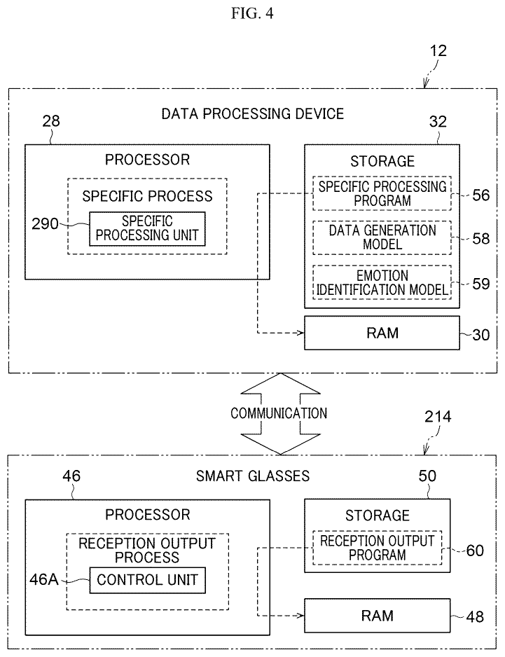

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

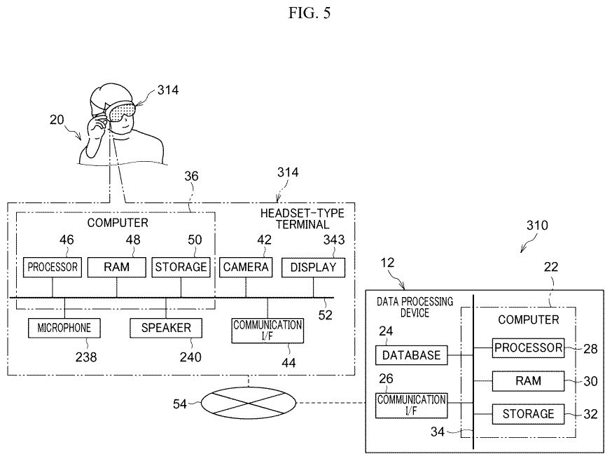

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

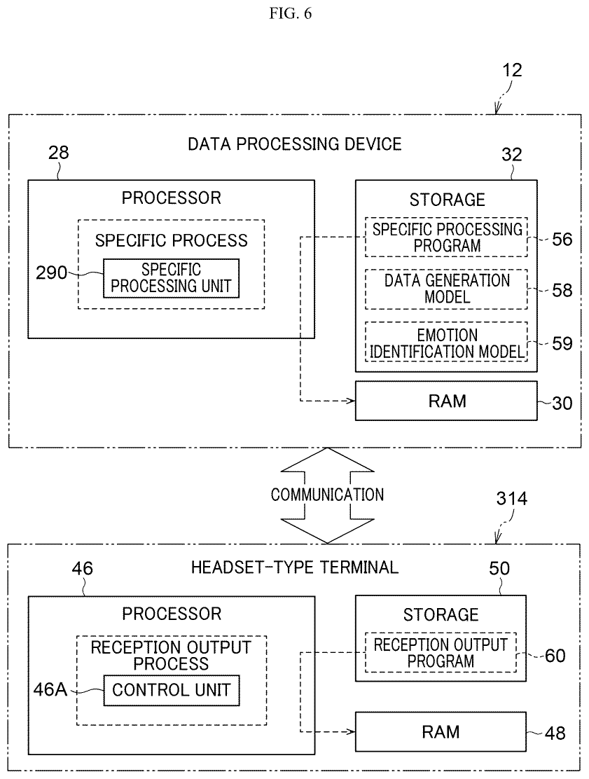

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

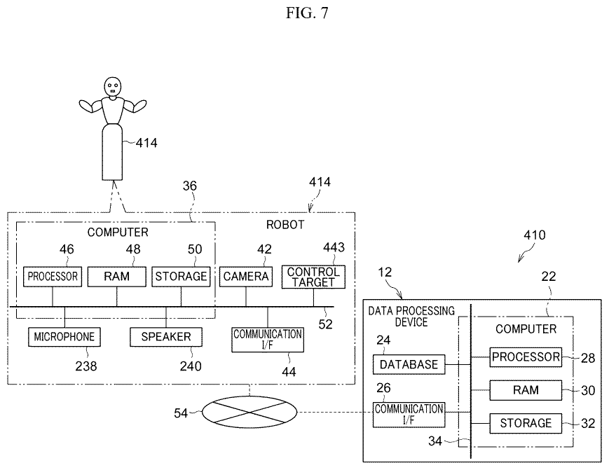

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

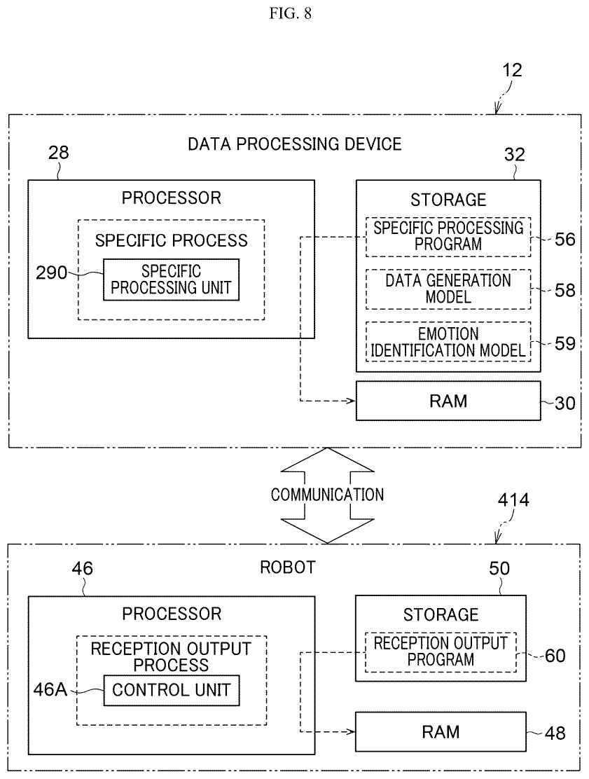

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

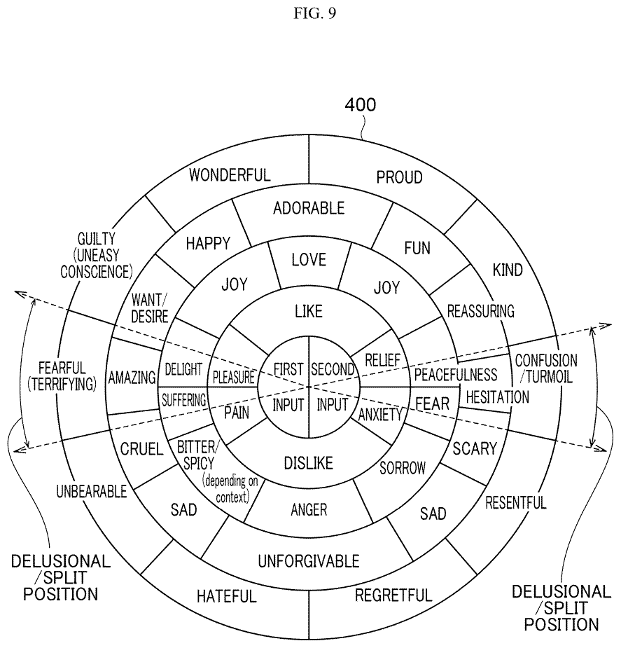

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

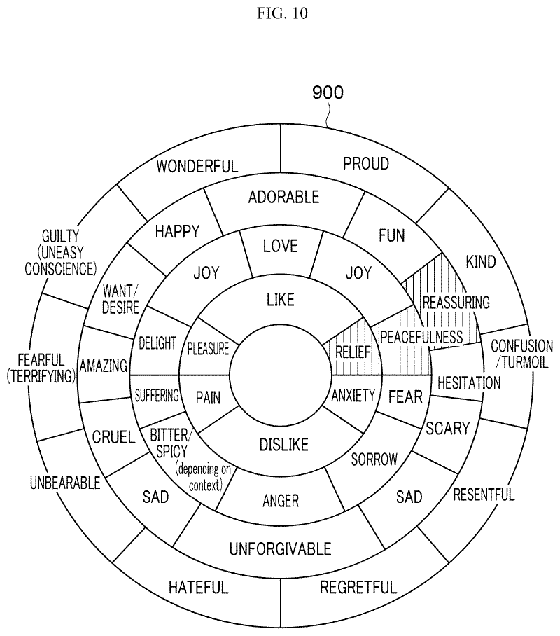

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire time-series audiovisual data related to a subject from an input/output device configured to capture audio information and video information in response to an interview question,
analyze an image included in the audiovisual data by using image processing software to extract feature information indicating at least a facial expression state, a gaze state, a head posture state, a body posture state, and an apparel state of the subject,
analyze an audio signal included in the audiovisual data by using speech recognition software to obtain audio text data and acoustic feature information, and extract feature information indicating at least a tone state, a fluency state, and a pronunciation state of the subject based on the acoustic feature information,
apply natural language processing software to the audio text data to extract semantic feature information indicating at least a structure, a relevance, a concreteness, and a consistency of answer content of the subject,
convert a plurality of feature information including the facial expression state, the gaze state, the head posture state, the body posture state, the apparel state, the tone state, the fluency state, the pronunciation state, and the semantic feature information into machine-readable input data according to a predetermined data structure, dynamically generate a prompt sentence that instructs a generative information processing model to perform scoring of respective elements and to generate an evaluation comment, and input the prompt sentence and the machine-readable input data into the generative information processing model, analyze element scores and the evaluation comment obtained from the generative information processing model, apply a weighting algorithm to the element scores to calculate a comprehensive score, and use emotion analysis software based on the plurality of feature information to generate an emotion index indicating an emotional state of the subject, and store the comprehensive score, the element scores, the evaluation comment, and the emotion index in a storage device and output them to a human user as an evaluation result via an output device.

### (Supplementary 2)

The system according to supplementary 1,
wherein the processor is configured to
set and adjust weighting parameters used in the weighting algorithm for the element scores via a user interface including a display device and an input device operable by the human user, and to recalculate the comprehensive score based on the set weighting parameters.

### (Supplementary 3)

The system according to supplementary 1,
wherein the processor is configured to
use a learning information processing model, which has been trained in advance based on the audiovisual data, the plurality of feature information, and past evaluation labels, to convert at least the facial expression state, the gaze state, the head posture state, the body posture state, the apparel state, the tone state, the fluency state, the pronunciation state, and the semantic feature information into numerical values, and to use the numerical values for generation of the prompt sentence input to the generative information processing model and for calculation of the comprehensive score.

### Application Example 1

### (Supplementary 1)

A system comprising a processor,
wherein the processor is configured to
acquire multiple evaluation elements including an answer content to a question, a facial expression, a body posture, an appearance, a speaking style, and a speech accent, and acquire operation behavior, working posture, and voice of a worker,
acquire, by a portable information terminal worn by the worker, time-series data including the facial expression and the voice by using an imaging device and an audio acquisition device, and transmit the time-series data to a server via a communication network,
apply, by the server, an image processing program to image data acquired from the imaging device to detect a face region and a body region of the worker and to extract facial feature information and posture feature information,
apply, by the server, a speech recognition program and an acoustic analysis program to audio data acquired from the audio acquisition device to extract text information and acoustic feature information,
generate, by the server, for each of the evaluation elements, a feature vector based on the facial feature information, the posture feature information, the acoustic feature information, and the answer content to the question,
generate, by the server, a prompt sentence including the feature vector and an evaluation instruction, and input the prompt sentence and the feature vector into a generative artificial intelligence model to cause the generative artificial intelligence model to generate an element score corresponding to each of the evaluation elements and an integrated score,
apply, by the server, a weighting algorithm to the element scores generated by the generative artificial intelligence model to calculate the integrated score, and analyze, by an emotion analysis function, an emotional state of a user and at least one of work efficiency and safety of the worker on the basis of the integrated score,
store, by the server, the integrated score and the element scores as time-series data in a storage device, and provide the scores in response to a request from an information display device for a manager, and
cause, by the information display device, the integrated score and the element scores obtained from the server to be visualized and displayed so that the manager can recognize a state of the worker and determine guidance or an improvement measure.

### (Supplementary 2)

The system according to supplementary 1,
wherein the processor is configured to set or change, through a user interface on the information display device, weighting parameters for the evaluation elements in the weighting algorithm so that a recruiter or the manager can adjust calculation conditions of the integrated score in accordance with an evaluation policy.

### (Supplementary 3)

The system according to supplementary 1,
wherein the processor is configured to perform scoring of each of the evaluation elements by using a machine learning model previously trained on an accumulated evaluation data set, and to use an output of the machine learning model as input feature information for the generative artificial intelligence model.

### Example 2

### (Supplementary 1)

A system comprising a processor,
wherein the processor is configured to
acquire response information to a question, face information of a person, body information of the person, appearance information of the person, voice expression information of the person, and voice pronunciation information of the person,
cause a generative artificial intelligence model to determine weighting information for respective evaluation elements corresponding to the face information, the body information, the appearance information, the voice expression information, the voice pronunciation information, and the response information, on the basis of a prompt sentence in natural language input by a user via a terminal device,
acquire voice information of the person and extract character information and acoustic feature information from the voice information by using a program having a speech recognition processing function,
calculate, on the basis of the character information and the acoustic feature information, basic scores for respective elements corresponding to the response information, the voice expression information, and the voice pronunciation information,
calculate, by using a program having an image processing function and on the basis of the face information, the body information, and the appearance information, basic scores for respective elements corresponding to an expression state, a posture state, and an appearance state,
apply weights to the basic scores for the respective elements on the basis of the weighting information determined by the generative artificial intelligence model, and calculate a comprehensive evaluation score by using a weighting algorithm,
output the comprehensive evaluation score and element scores for the respective elements as evaluation results that are referable by the user, and
acquire an emotional state of the user and recognize the emotional state of the user by using a program having an emotion analysis function.

### (Supplementary 2)

The system according to supplementary 1,
wherein the processor is configured to acquire, as the prompt sentence, a natural language instruction including a weighting request for each evaluation element input by the user via the terminal device, and input the prompt sentence to the generative artificial intelligence model so as to dynamically change the weighting information.

### (Supplementary 3)

The system according to supplementary 1,
wherein the processor is configured to execute the speech recognition processing function, the image processing function, and an analysis function for the response information, which are related to calculation of the basic scores, by using machine learning models trained with past evaluation data sets.

### Application Example 2

### (Supplementary 1)

A system comprising a processor,
wherein the processor is configured to
acquire heterogeneous input information including response information to questions, audio information, and image information, extract linguistic feature information from the response information by using a natural language processing unit, extract acoustic feature information from the audio information by using an acoustic signal processing unit, and extract facial expression feature information and posture feature information from the image information by using an image processing unit,
generate, based on the linguistic feature information, the acoustic feature information, and the image feature information, integrated feature information, generate, for each evaluation element, summary information of characteristics from the integrated feature information, and construct a prompt sentence including the summary information and evaluation policy information, and input the prompt sentence into a generative artificial intelligence model to obtain, from the generative artificial intelligence model, element-specific scores corresponding to the evaluation elements and explanation information,
input the integrated feature information into a machine learning model learned on the basis of a past evaluation data set, generate, from the machine learning model, machine learning scores corresponding to the evaluation elements, and integrate the machine learning scores with the element-specific scores obtained from the generative artificial intelligence model to calculate integrated scores for the respective evaluation elements,
operate an emotion engine including an emotion estimation model on the basis of the acoustic feature information, the image feature information, and the linguistic feature information, and generate an emotion score indicating an emotional state of an evaluated subject or an evaluating subject,
apply, by using a numerical computation unit, a weighting algorithm to the integrated scores for the respective evaluation elements and the emotion score in accordance with weighting parameters set by a user, calculate a comprehensive evaluation score, and dynamically correct the weighting parameters in accordance with the emotion score, and
generate evaluation result information including the comprehensive evaluation score, the integrated scores for the respective evaluation elements, and the explanation information, transmit the evaluation result information to a terminal device, and store the evaluation result information in a storage unit.

### (Supplementary 2)

The system according to supplementary 1,
wherein the processor is configured to
cause a user, via a user interface unit, to set or change weighting parameters for each evaluation element and evaluation conditions including evaluation viewpoints, output format, and score range in the prompt sentence, and reflect the set or changed evaluation conditions in both generation processing of the prompt sentence for the generative artificial intelligence model and calculation processing of the comprehensive evaluation score.

### (Supplementary 3)

The system according to supplementary 1,
wherein the processor is configured to
execute, as learning processing of the machine learning model and the emotion estimation model, processing including acquiring past interview history information or dialogue history information from a database, performing, by a preprocessing unit, missing-value completion, feature extraction, and data partitioning on the acquired information, executing accuracy evaluation by a model selection unit that explores a plurality of learning algorithms and a plurality of hyperparameter candidates, and storing a selected trained model in the system for use in inference processing.

What is claimed is:

1. A system comprising:
circuitry configured to:
receive, via a communication interface coupled to a packet-switched network, time-series audiovisual data from a terminal device, the time-series audiovisual data including image data and audio data;
apply an image processing program to the image data to extract, for each of a plurality of visual evaluation elements, a feature vector representing at least facial expression state, gaze state, head posture state, body posture state, and apparel state of a subject;
apply a speech recognition program and an acoustic analysis program to the audio data to extract audio text data and acoustic feature information, and derive, from the audio text data and the acoustic feature information, feature vectors representing tone state, fluency state, and pronunciation state of the subject;
apply a natural language processing program to the audio text data to extract semantic feature information representing at least structure, relevance, and concreteness of answer content of the subject;
normalize and concatenate the feature vectors and the semantic feature information into a unified feature representation according to a predetermined data structure;
input the unified feature representation into a machine learning model trained on a past evaluation data set to generate machine learning scores for respective evaluation elements;
generate a prompt sentence incorporating the machine learning scores and selected feature summaries, and input the prompt sentence and the unified feature representation into a generative neural network model to obtain element scores and evaluation comment information from the generative neural network model;
integrate the machine learning scores and the element scores into integrated evaluation scores for the respective evaluation elements, apply a weighting algorithm using weighting parameters to compute a comprehensive evaluation score, and operate an emotion engine on the unified feature representation to generate an emotion score; and
store the comprehensive evaluation score, the integrated evaluation scores, the evaluation comment information, and the emotion score in a storage device, and transmit the comprehensive evaluation score and the evaluation comment information to the terminal device via the communication interface.

2. The system according to claim 1, wherein the circuitry is configured to dynamically correct the weighting parameters in accordance with the emotion score, such that the weighting algorithm reflects a current emotional state of the subject when computing the comprehensive evaluation score.

3. The system according to claim 2, wherein the circuitry is configured to receive a natural language prompt sentence from a user via the terminal device, input the natural language prompt sentence into the generative neural network model to obtain weighting information specifying a weight for each of the evaluation elements, and apply the weighting information as the weighting parameters in the weighting algorithm.

4. The system according to claim 3, wherein the circuitry is configured to validate that each weight value output by the generative neural network model falls within a predetermined range and normalize the weight values such that a sum of the weights satisfies a constraint, and store the weighting parameters in association with an evaluation session identifier.

5. The system according to claim 4, wherein the circuitry is configured to propagate the weighting parameters to both a prompt sentence generation stage and a numerical score aggregation stage, such that a same set of evaluation conditions controls the generative neural network model interaction and the comprehensive evaluation score calculation.

6. The system according to claim 1, wherein the circuitry is configured to compute, as the apparel state, a numerical score derived from a deep learning-based apparel classifier that assigns a formality level label to an upper-body region of the subject, and aggregate classifier probabilities over a plurality of image frames to reduce noise in the apparel state feature vector.

7. The system according to claim 6, wherein the circuitry is configured to compute, as the fluency state, metrics including speech rate, average pause duration derived from energy-level intervals in the audio data, and a frequency count of disfluency markers identified in the audio text data.

8. The system according to claim 7, wherein the circuitry is configured to compute, as the pronunciation state, a phoneme-level error rate derived by comparing phoneme sequences inferred from the audio data against target phoneme models for a reference language variety.

9. The system according to claim 8, wherein the circuitry is configured to apply z-score normalization or min-max scaling using parameters computed during a training phase to each dimension of the feature vectors prior to concatenating the feature vectors into the unified feature representation.

10. The system according to claim 1, wherein the circuitry is configured to construct the prompt sentence by inserting feature summary fragments and preliminary score values into a text template stored in a prompt generation module, the prompt sentence including an evaluation instruction that specifies required output fields and a score range for the generative neural network model.

11. The system according to claim 10, wherein the circuitry is configured to receive generated text output from the generative neural network model, parse element scores and the evaluation comment information from the generated text output, and validate a final score output by enforcing an allowed adjustment range relative to a preliminary comprehensive score.

12. The system according to claim 11, wherein the circuitry is configured to integrate the machine learning scores and the element scores by combining outputs of the machine learning model and outputs of the generative neural network model for each evaluation element using a learned fusion function.

13. The system according to claim 12, wherein the circuitry is configured to generate, as the evaluation comment information, a natural language explanation of evaluation results for the subject, and store the evaluation comment information alongside the integrated evaluation scores and the emotion score indexed by an evaluation session identifier and a timestamp.

14. The system according to claim 1, wherein the circuitry is configured to operate the emotion engine using a recurrent neural network or temporal convolutional network that takes as input time-series sequences of facial expression probabilities, pitch contours, and speech energy patterns, and outputs scores for stress, confidence, and engagement as components of the emotion score.

15. The system according to claim 14, wherein the circuitry is configured to update the machine learning model and the emotion engine by acquiring past evaluation history records from a database, applying preprocessing including missing-value completion and feature extraction, and selecting a trained model from among a plurality of learning algorithms and hyperparameter candidates using accuracy evaluation.

16. The system according to claim 1, wherein the circuitry is configured to receive, from a portable wearable terminal device, continuously streamed time-series image data and audio data corresponding to a worker, store the integrated evaluation scores as time-series data indexed by session identifier and timestamp, and provide the time-series data to an information display device for monitoring work efficiency and safety of the worker.

17. The system according to claim 16, wherein the circuitry is configured to generate evaluation result information including the comprehensive evaluation score, the integrated evaluation scores for the respective evaluation elements, and the evaluation comment information, and transmit the evaluation result information to the terminal device in a structured data format.

18. A system comprising:
circuitry configured to:
receive, via a communication interface coupled to a packet-switched network, time-series image data and audio data from a terminal device;
apply an image processing program to the image data to detect a face region and a body region of a subject and extract facial feature information including facial expression state, gaze state, and head posture state, and posture feature information including body posture state and apparel state;
apply a speech recognition program to the audio data to generate audio text data and apply an acoustic analysis program to the audio data to extract acoustic feature information including tone state, fluency state, and pronunciation state, and apply a natural language processing program to the audio text data to extract semantic feature information;
normalize the facial feature information, the posture feature information, the acoustic feature information, and the semantic feature information and concatenate the normalized information into a unified feature representation following a predetermined schema;
input the unified feature representation into a machine learning model to generate machine learning scores for evaluation elements including facial expression, body posture, apparel, tone, fluency, pronunciation, and answer content;
generate a prompt sentence including the machine learning scores, selected feature summaries, and an evaluation instruction, and input the prompt sentence and the unified feature representation into a generative neural network model to obtain element scores and evaluation comment information;
apply a weighting algorithm using weighting parameters to the machine learning scores and the element scores to compute a comprehensive evaluation score, operate an emotion engine on the unified feature representation to generate an emotion score, and dynamically correct the weighting parameters based on the emotion score; and
store the comprehensive evaluation score, the element scores, the evaluation comment information, and the emotion score in a storage device indexed by an evaluation session identifier, and transmit the comprehensive evaluation score and the evaluation comment information to the terminal device via the communication interface.

19. The system according to claim 18, wherein the circuitry is configured to receive a natural language prompt sentence specifying evaluation conditions from a user via the terminal device, input the natural language prompt sentence into the generative neural network model to obtain weighting information for each evaluation element, and apply the weighting information as the weighting parameters to both the prompt sentence generation and the comprehensive evaluation score calculation.

20. A method comprising:
receiving, via a communication interface coupled to a packet-switched network, time-series audiovisual data from a terminal device, the time-series audiovisual data including image data and audio data;
applying an image processing program to the image data to extract, for each of a plurality of visual evaluation elements, a feature vector representing facial expression state, gaze state, head posture state, body posture state, and apparel state of a subject;
applying a speech recognition program and an acoustic analysis program to the audio data to extract audio text data and acoustic feature information, and deriving, from the audio text data and the acoustic feature information, feature vectors representing tone state, fluency state, and pronunciation state of the subject;
applying a natural language processing program to the audio text data to extract semantic feature information representing at least structure, relevance, and concreteness of answer content of the subject;
normalizing and concatenating the feature vectors and the semantic feature information into a unified feature representation according to a predetermined data structure;
inputting the unified feature representation into a machine learning model trained on a past evaluation data set to generate machine learning scores for respective evaluation elements;
generating a prompt sentence incorporating the machine learning scores and selected feature summaries, and inputting the prompt sentence and the unified feature representation into a generative neural network model to obtain element scores and evaluation comment information from the generative neural network model;
integrating the machine learning scores and the element scores into integrated evaluation scores for the respective evaluation elements, applying a weighting algorithm using weighting parameters to compute a comprehensive evaluation score, and operating an emotion engine on the unified feature representation to generate an emotion score; and
storing the comprehensive evaluation score, the integrated evaluation scores, the evaluation comment information, and the emotion score in a storage device, and transmitting the comprehensive evaluation score and the evaluation comment information to the terminal device via the communication interface.
